(19) United States
(12) Patent Application Publication
(10) Pub. No.: US 2010/0274772 A1
(43) Pub. Date: Oct. 28, 2010

(54) COMPRESSED DATA OBJECTS REFERENCED VIA ADDRESS REFERENCES AND COMPRESSION REFERENCES

(76) Inventor: Allen Samuels, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/429,140

(22) Filed: Apr. 23, 2009

(51) Int. Cl. G06F 17/30

(52) U.S. Cl. 707/693; 707/E17.055

(57) ABSTRACT

A computing device maintains a mapping of a virtual storage to a physical storage. The mapping includes address references from data included in the virtual storage to one or more compressed data objects included in the physical storage. At least one of the one or more compressed data objects has been compressed at least in part by replacing portions of an uncompressed data object with compression references to matching portions of previously generated compressed data objects.

### TECHNICAL FIELD

Embodiments of the present invention relate to data storage, and more specifically to a mechanism for storing data in a compressed format in a storage cloud and for generating snapshots of the stored data.

### BACKGROUND

Enterprises typically include expensive collections of network storage, including storage area network (SAN) products and network attached storage (NAS) products. As an enterprise grows, the amount of storage that the enterprise must maintain also grows. Thus, enterprises are continually purchasing new storage equipment to meet their growing storage needs. However, such storage equipment is typically very costly. Moreover, an enterprise has to predict how much storage capacity will be needed, and plan accordingly.

Cloud storage has recently developed as a storage option. Cloud storage is a service in which storage resources are provided on an as needed basis, typically over the internet. With cloud storage, a purchaser only pays for the amount of storage that is actually used. Therefore, the purchaser does not have to predict how much storage capacity is necessary. Nor does the purchaser need to make up front capital expenditures for new network storage devices. Thus, cloud storage is typically much cheaper than purchasing network devices and setting up network storage.

Despite the advantages of cloud storage, enterprises are reluctant to adopt cloud storage as a replacement to their network storage systems due to its disadvantages. First, most cloud storage uses completely different semantics and protocols than have been developed for file systems. For example, network storage protocols include common internet file system (CIFS) and network file system (NFS), while protocols used for cloud storage include hypertext transport protocol (HTTP) and simple object access protocol (SOAP). Additionally, cloud storage does not provide any file locking operations, nor does it guarantee immediate consistency between different file versions. Therefore, multiple copies of a file may reside in the cloud, and clients may unknowingly receive old copies. Additionally, storing data to and reading data from the cloud is typically considerably slower than reading from and writing to a local network storage device. Finally, cloud security models are incompatible with existing enterprise security models. Embodiments of the present invention combine the advantages of network storage devices and the advantages of cloud storage while mitigating the disadvantages of both.

### BRIEF DESCRIPTION OF THE DRAWINGS

The present invention is illustrated by way of example, and not by way of limitation, in the figures of the accompanying drawings and in which:

FIG. 1 illustrates an exemplary network architecture, in which embodiments of the present invention may operate;

FIG. 2 illustrates one embodiment of a simplified network architecture that includes a networked client, user agent, a central manager and a storage cloud;

FIG. 3 illustrates a block diagram of a local network including a user agent connected with a client, in accordance with one embodiment of the present invention;

FIG. 4 illustrates a block diagram of a central manager, in accordance with one embodiment of the present invention;

FIG. 5A illustrates a Cnode, in accordance with one embodiment of the present invention;

FIG. 5B illustrates an exemplary directed acyclic graph representing the reference counts for data stored in a storage cloud, in accordance with one embodiment of the present invention;

FIG. 6A illustrates a storage cloud, in accordance with one embodiment of the present invention;

FIG. 6B illustrates an exemplary network architecture in which multiple storage clouds are utilized, in accordance with one embodiment of the present invention;

FIG. 7 is a flow diagram illustrating one embodiment of a method for generating a compressed data object;

FIG. 8 is a flow diagram illustrating one embodiment of a method for responding to a client read request;

FIG. 9 illustrates a sequence diagram of one embodiment of a file read operation;

FIG. 10 is a flow diagram illustrating one embodiment of a method for responding to a client write request;

FIG. 11 is a flow diagram illustrating another embodiment of a method for responding to a client write request;

FIG. 12A is a sequence diagram of one embodiment of a write operation;

FIG. 12B is a sequence diagram of one embodiment of a read operation, in which the authoritative data for the file being opened is at a user agent;

FIG. 13 is a flow diagram illustrating one embodiment of a method for responding to a client delete request;

FIG. 14 is a flow diagram illustrating one embodiment of a method for managing reference counts;

FIG. 15A illustrates a virtual hierarchical file system at time T=1, in accordance with one embodiment of the present invention;

FIG. 15B illustrates a mapping from a virtual file system to compressed data objects stored in a cloud storage and local caches of user agents at the time T=1, in accordance with one embodiment of the present invention;

FIG. 15C illustrates a directed acyclic graph that shows the address references from data in a virtual file system and compression references from compressed data objects, in accordance with one embodiment of the present invention;

FIG. 15D illustrates a table of reference counts for each of the data objects at time T=1, in accordance with one embodiment of the present invention;

FIG. 16A is a flow diagram illustrating one embodiment of a method for generating snapshots of virtual storage;

FIG. 16B is a flow diagram illustrating another embodiment of a method for generating snapshots of virtual storage;

FIG. 17A illustrates a virtual hierarchical file system at time T=2, in accordance with one embodiment of the present invention;

FIG. 17B illustrates a mapping from a virtual file system to compressed data objects stored in a cloud storage and local caches of user agents at the time T=2, in accordance with one embodiment of the present invention;

FIG. 17C illustrates a directed acyclic graph that shows the address references from data in the virtual file system and compression references from compressed data objects, in accordance with one embodiment of the present invention;

FIG. 17D illustrates a table of reference counts for each of the data objects at time T=2, in accordance with one embodiment of the present invention;

FIG. 17E illustrates a directed acyclic graph that shows the address references from data in the virtual file system and compression references from compressed data objects, in accordance with one embodiment of the present invention;

FIG. 17F illustrates a table of reference counts for each of the data objects at time T=2 after a virtual point-in-time copy was generated, in accordance with one embodiment of the present invention;

FIG. 17G illustrates a directed acyclic graph that shows the address references from data in the virtual file system and compression references from compressed data objects, in accordance with one embodiment of the present invention;

FIG. 17H illustrates a table of reference counts for each of the data objects at time T=2 after a physical PIT copy was generated, in accordance with one embodiment of the present invention; and

FIG. 18 illustrates a diagrammatic representation of a machine in the exemplary form of a computer system within which a set of instructions, for causing the machine to perform any one or more of the methodologies discussed herein, may be executed.

### DETAILED DESCRIPTION

Described herein is a method and apparatus for enabling clients to access data from a storage cloud using standard file system protocols. In one embodiment, a computing device maintains a mapping of a virtual storage to a physical storage. The mapping includes address references from data included in the virtual storage to one or more compressed data objects included in the physical storage. At least one of the one or more compressed data objects has been compressed at least in part by replacing portions of an uncompressed data object with compression references to matching portions of previously generated compressed data objects. In one embodiment, the computing device responds to a request to access information represented by the data from a client by transferring one or more first compressed data objects referenced by the data via the address references and one or more second compressed data objects referenced by the one or more first compressed data objects via the compression references to the client.

In another embodiment, a computing device manages reference counts for multiple compressed data objects. Each of the compressed data objects has a reference count representing a number of address references made to the compressed data object by data included in a virtual storage and a number of compression references made to the compressed data object by other compressed data objects. The computing device determines when it is safe to delete a compressed data object based on the reference count for the compressed data object.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “mapping”, “maintaining”, “incrementing”, “determining”, “responding”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

### I. System Architecture

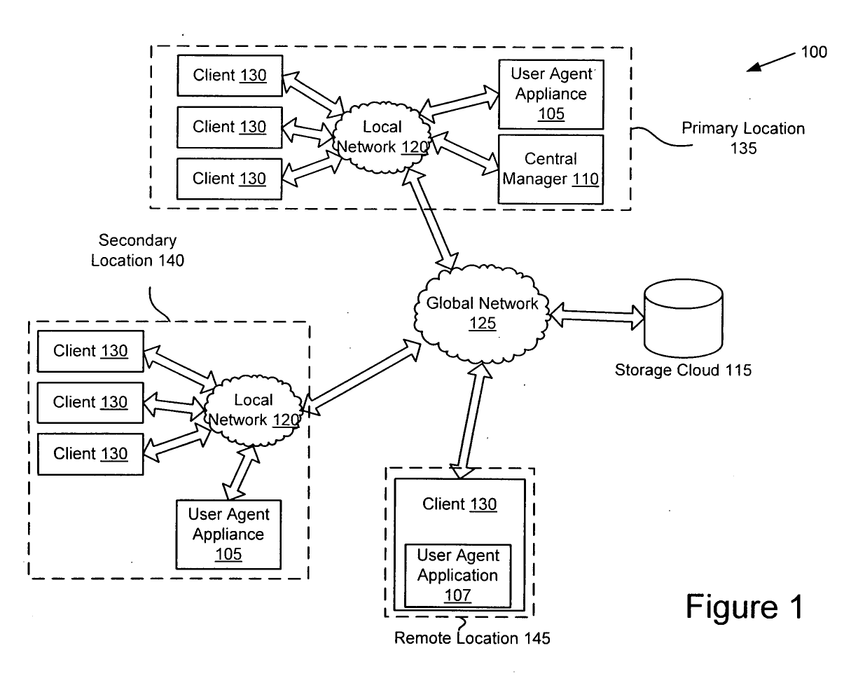

FIG. 1 illustrates an exemplary network architecture 100, in which embodiments of the present invention may operate. The network architecture 100 may include multiple locations (e.g., primary location 135, secondary location 140, remote location 145, etc.) and a storage cloud 115 connected via a global network 125. The global network 125 may be a public network, such as the Internet, a private network, such as a wide area network (WAN), or a combination thereof.

The storage cloud 115 is a dynamically scalable storage provided as a service over a public network (e.g., the Internet) or a private network (e.g., a wide area network (WAN). Some examples of storage clouds include Amazon's Simple Storage Service (S3), Nirvanix Storage Delivery Network (SDN), Windows Live SkyDrive, and Mosso Cloud Files. Most storage clouds provide unlimited storage through a simple web services interface (e.g., using standard HTTP commands or SOAP commands). However, most storage clouds 115 are not capable of being interfaced using standard file system protocols such as common internet file system (CIFS), direct access file systems (DAFS) or network file system (NFS).

Each location in the network architecture 100 may be a distinct location of an enterprise. For example, the primary location 135 may be the headquarters of the enterprise, the secondary location 140 may be a branch office of the enterprise, and the remote location 145 may be the location of a traveling salesperson for the enterprise. Each location includes at least one client 130 and a user agent. Some locations (e.g., primary location 135 and secondary location 140) may include multiple clients 130 and a user agent appliance 105 connected via a local network 120. The local network 120 may be a local area network (LAN), campus area network (CAN), metropolitan area network (MAN), or combination thereof. Other locations (e.g., remote location 145) may include only one or a few clients 130, one of which hosts a user agent application 107. Additionally, in one embodiment, one location (e.g., the primary location 135) includes a central manager 110 connected to that location's local network 120. In another embodiment, the central manager 110 is provided as a service (e.g., by a distributor or manufacturer of the user agents), and does not reside on a local network of an enterprise.

In one embodiment, each of the clients 130 is a standard computing device that is configured to access and store data on network storage. Each client 130 includes a physical hardware platform on which an operating system runs. Different clients 130 may use the same or different operating systems. Examples of operating systems that may run on the clients 130 include various versions of Windows, Mac OS X, Linux, Unix, O/S 2, etc.

In a conventional network storage architecture, each of the local networks 120 would include storage devices attached to the network for providing storage to clients 130, and possibly a storage server that provides access to those storage devices. For enterprises that have multiple locations, a conventional network storage architecture may also include a wide area network optimization (WANOpt) appliance at one or more locations that optimize access to storage between the locations. In contrast, the illustrated network architecture 100 does not include any network storage devices attached to the local networks 120. Rather, in one embodiment of the present invention, the clients 130 store all data on the storage cloud 115 as though the storage cloud were network storage of the conventional type. In another embodiment, data is stored both on the storage cloud 115 and on conventional network storage. For example, a client 130 may have a first mounted directory that maps to a conventional network storage and a second mounted directory that maps to the storage cloud 115.

The user agents (e.g., user agent appliances 105 and user agent application 107) and central manager 110 operate in concert to provide the storage cloud 115 to the clients 130 to enable those clients 130 to store data to the storage cloud 115 using standard file system semantics (e.g., CIFS or NFS). Together, the user agents and central manager 110 emulate the existing file system stack that is understood by the clients 130. Therefore, the user agents 105, 107 and central manager 110 can together provide a functional equivalent to traditional file system servers, and thus eliminate any need for traditional file system servers. In one embodiment, the user agents and central manager 110 together provide a cloud storage optimized file system that sits between an existing file system stack of a conventional file system protocol (e.g., NFS or CIFS) and physical storage that includes the storage cloud and caches of the user agents.

The more traffic that goes to the central manager 110, the greater the chance of the central manager 110 becoming a performance bottleneck. However, there is a minimum amount of data that should flow through the central manager 110 to maintain global coherency and file synchronization. Moreover, increasing the amount of data that flows through the central manager 110 can increase the efficiency of compression/deduplication algorithms. Centralization is also advantageous where global knowledge of access patterns is useful. For example, if the central manager 110 has an estimate of the cache contents of the various user agents 105, 107, it could optimize the case of modifying a “hot” file (i.e., one that is frequently accessed across the user agents 105, 107) by speculatively and proactively instructing the various user agents 105, 107 to “prefetch” the modifications to the hot file. Therefore, there is a balance between how much traffic flows through the central manager 305, and how much flows directly between the user agents 105, 107 and the storage cloud 115.

In one embodiment, the storage cloud 115 may be treated as a virtual block device, in which the central manager 110 essentially acts as a virtual disk backed up to the storage cloud 115. In such an embodiment, the storage cloud 115 would be cached locally at the central manager 110, and all data traffic would flow through the central manager 110. For example, in one embodiment, for every metadata transaction, for every read or write transaction, every time a new chunk of disk space is needed, etc., a message will be sent to the central manager 110. In another embodiment, the central manager 110 may be virtually or completely eliminated.

Preferably, the amount of traffic that flows through the central manager 110 is somewhere between the two ends of the spectrum. In one embodiment, data transactions are divided into two categories: metadata transactions and data payload transactions. Data payload transactions are transactions that include the data itself (including references to other data), and make up the bulk of the data that is transmitted. Metadata transactions are transactions that include data about the data payload, and make up a minority of the data that is transmitted. In one embodiment, data payload transactions flow directly between the user agent 105, 107 and the storage cloud 115, and metadata transactions flow between the central manager 110 and the user agent 105, 107. Therefore, in one embodiment, a majority of traffic for reading from and writing to the storage cloud 115 goes directly between user agent 105, 107 and the storage cloud 115, and only a minimum amount of traffic goes through the central manager 110.

In one embodiment, all compression/deduplication is performed by the user agents 105, 107. In such an embodiment, user agents 105, 107 are able to compress and store data with only minimal involvement by central manager 110. In another embodiment, all encryption is also performed at the user agents 105, 107.

In one embodiment, when a client 130 attempts to read data, the client 130 hands a local user agent (the user agent that shares the client's location) a name of the data. The user agent 105, 107 checks with the central manager 110 to determine the most current version of the data and a location or locations for the most current version in the storage cloud 115 and/or in a cache of another user agent 105, 107. The user agent 105, 107 then uses the information returned by the central manager 110 to obtain the data from the storage cloud 115. In one embodiment, such data is obtained using protocols understood by the storage cloud 115. Examples of such protocols include SOAP, representational state transfer (REST), HTTP, HTTPS, etc. In one embodiment, the storage cloud 115 does not understand any file system protocols, such as CIFS or NFS.

Once the data is obtained, it is decompressed and decrypted by the user agent 105, 107, and then provided to the client 130. To the client 130, the data is accessed using a file system protocol (e.g., CIFS or NFS) as though it were uncompressed clear text data on local network storage. It should be noted, though, that the data may still be separately encrypted over the wire by the file system protocol that the client 130 used to access the data.

Similarly, when a client 130 attempts to store data, the data is first sent to the local user agent 105, 107. The user agent 105, 107 uses information contained in a local cache to compress the data, and checks with the central manager 110 to verify that the compression is valid. If the compression is valid, the user agent 105, 107 encrypts the data (e.g., using a key provided by the central manager 110), and writes it to the storage cloud 115 using the protocols understood by the storage cloud 115.

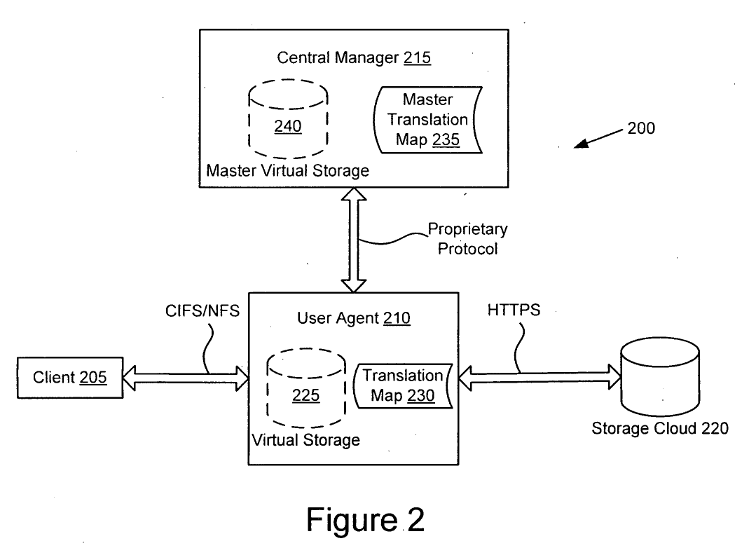

FIG. 2 illustrates one embodiment of a simplified network architecture 200 that includes a networked client 205, user agent 210 (e.g., a user agent appliance or a user agent application), central manager 215 and storage cloud 220. In one embodiment, the simplified network architecture 200 represents a portion of the network architecture 100 of FIG. 1. Referring to FIG. 2, the user agent 210 communicates with the client 205 using CIFS commands, NFS commands, server message block (SMB) commands and/or other file system protocol commands that may be sent using, for example, the internet small computer system interface (iSCSI) or fiber channel. NFS and CIFS allow files to be shared transparently between machines (e.g., servers, desktops, laptops, etc.). Both are client/server applications that allow a client to view, store and update files on a remote storage as though the files were on the client's local storage.

In one embodiment, the user agent 210 includes a virtual storage 225 that is accessible to the client 205 via the file system protocol commands (e.g., via NFS or CIFS commands). The virtual storage 225 may be, for example, a virtual file system or a virtual block device. The virtual storage 225 appears to the client 205 as an actual storage, and thus includes the names of data (e.g., file names or block names) that client 205 uses to identify the data. For example, if client wants a file called newfile.doc, the client requests newfile.doc from the virtual storage 225 using a CIFS or NFS read command. In one embodiment, by presenting the virtual storage 225 to client 205 as though it were a physical storage, user agent 210 acts as a storage proxy for client 205.

The user agent 210 communicates with the storage cloud 220 using cloud storage protocols such as HTTP, hypertext transport protocol over secure socket layer (HTTPS), SOAP, REST, etc. In one embodiment, the user agent 210 includes a translation map that maps the names of the data (e.g., file names or block names) that are used by the client 205 into the names of data objects (e.g., compressed data objects) that are stored in a local cache of the user agent 210 and/or in the storage cloud 220. In another embodiment, the user agent 210 includes no translation map, and instead requests the latest translation for specific data from the central manager 215 as requests are received from clients 205.

The data objects are each identified by a permanent globally unique identifier. Therefore, the user agent 210 can use the translation map 230 to retrieve data objects from either the storage cloud 220 or a local cache in response to a request from client 205 for data included in the virtual storage 225. In example, client 205 requests to read newfile.doc, which is included in virtual storage 225, using CIFS. User agent 210 translates newfile.doc into compressed data object A, checks a local cache for the data object, and retrieves compressed data object A from storage cloud 220 using HTTPS if the data object is not in the local cache. User agent 210 then decompresses compressed data object A and returns the information that was included in compressed data object A to client 205 using CIFS.

The storage cloud 220 is an object based store. Data objects stored in the storage cloud 220 may have any size, ranging from a few bytes to the upper size limit allowed by the storage cloud (e.g., 5 GB).

In one embodiment, the central manager 215 and user agent 210 do not perform rewrites. Therefore, the data object is the smallest unit that can be operated on within the storage cloud for at least some operations. For example, in one embodiment, sub-object operations are not permitted. In one embodiment, user agent 210 can read portions of a data object, but cannot write a portion of a data object. As a consequence, if a very large file is modified, the entire file needs to be written again to the storage cloud 220. To mitigate the cost of such writes, in one embodiment large data objects are broken into multiple smaller data objects, which are smaller than the maximum size allowed by the storage cloud 220. A small change in a file may result in changes to only a few of the smaller data objects into which the file has been divided.

The size of the data objects may be fixed or variable. The size of the data objects may be chosen based on how frequently a file is written (e.g., frequency of rewrite), cost per operation charged by cloud storage provider, etc. If cost per operation was free, the size of the data objects would be set very small. This would generate many I/O requests. Since storage cloud providers charge per I/O operation, very small data object sizes are therefore not desirable. Moreover, storage providers round the size of data objects up. For example, if 1 byte is stored, a client may be charged for a kilobyte. Therefore, there is an additional cost disadvantage to setting a data objects size that is smaller than the minimum object size used by the storage cloud 220.

There is also overhead time associated with setting the operations up for a read or a write. Typically, about the same amount of overhead time is required regardless of the size of the data objects. Therefore, a file divided into larger data objects will have fewer data objects, which will in turn require fewer read and fewer write operations. Therefore, for small data objects the setup cost dominates, and for large data objects the setup cost is only a small fraction of the total cost spent obtaining the data.

Another consideration is that for some compression algorithms, compression cannot be achieved across data object boundaries. Therefore, by reducing the data object size the compression ratio may be restricted. For example, in a hash compression scheme, compression cannot be achieved across data object boundaries. However, other compression schemes, like the reference compression scheme described herein, may permit compression across data object boundaries.

These competing concerns should be considered in choosing the block sizes. In one embodiment, data objects have a size on the order of one or a few megabytes. In another embodiment, data object sizes range from 64 Kb to 10 Mb. In one embodiment, the useful data object sizes vary depending on the operational characteristics of the network and cloud storage subsystems. Thus as the capabilities of these systems increase the useful data block sizes could similarly increase to avoid having setup times limit overall performance.

The translation map 230 can include a one to many mapping, in which data in the virtual storage 225 maps to multiple data objects in the storage cloud 220. Additionally, the translation map 230 can include a many to one mapping, in which multiple articles of data in the virtual storage 225 maps to a single data object in the storage cloud 220.

In one embodiment, the user agent 210 communicates with the central manager 215 using a standard or proprietary protocol. In one embodiment, central manager 215 includes a master translation map 235 and a master virtual storage 240. In one embodiment, whenever a user agent 210 makes a modification to virtual storage 225 and translation map 230 (e.g., if a client 205 requests that a new file be written, an existing file be modified or an existing file be deleted), it reports the modification to central manager 215. The master virtual storage 240 and master translation map 235 are then updated to reflect the change. The central manager 215 can then report the modification to all other user agents so that they share a unified view of the same virtual storage 225. The central manager 215 can also perform locking for user agents 210 to further ensure that the virtual storage 225 and translation map 230 of the user agents are synchronized.

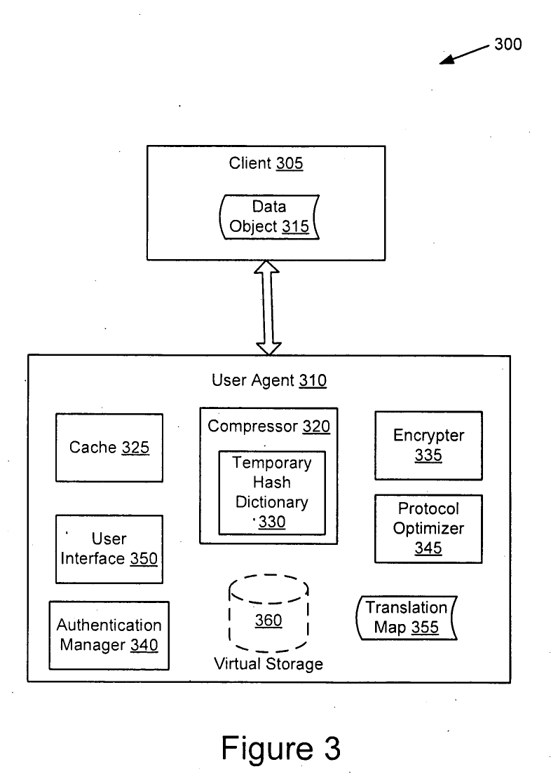

FIG. 3 illustrates a block diagram of a local network 300 including a user agent 310 connected with a client 305. The user agent 310 may be a user agent appliance (e.g., such as user agent appliance 105 of FIG. 1) or a user agent application (e.g., such as user agent application 107 of FIG. 1). The user agent application may be located on a client or on a third party machine. Functionally, a user agent appliance and a user agent application perform the same tasks. In either case, in one embodiment, the user agent 310 is responsible for acting as system storage to clients (e.g., terminating read and write requests), communicating with the central manager, compressing and decompressing data, encrypting and decrypting data, and reading data from and writing data to cloud storage. In another embodiment, the user agent 310 is responsible for performing a subset of these tasks. However, a user agent appliance is an appliance having a processor, memory, and other resources dedicated solely to these tasks. In contrast, a user agent application is software hosted by a computing device that may also include other applications with which the user agent application competes for system resources. Typically, a user agent appliance is responsible for handling storage for many clients on a local network, and a user agent application is responsible for handling storage for only a single client or a few clients.

In one embodiment, the user agent 310 includes a cache 325, a compressor 320, an encrypter 335, a virtual storage 360 and a translation map 355. In one embodiment, the virtual storage 360 and translation map 355 operate as described above with reference to virtual storage 225 and translation map 230 of FIG. 2.

Referring to FIG. 3, the cache 325 in one embodiment contains a subset of data stored in the storage cloud. The cache 325 may include, for example, data that has recently been accessed by one or more clients 305 that are serviced by user agent 310. The cache in one embodiment also contains data that has not yet been written to the storage cloud. For example, the cache 325 may include a modified version of a file that has not yet been saved in the storage cloud. Upon receiving a request to access data, user agent 310 can check the contents of cache 325 before requesting data from the storage cloud. That data that is already stored in the cache 325 does not need to be obtained from the storage cloud.

In one embodiment, the cache 325 stores the data as clear text that has neither been compressed nor encrypted. This can increase the performance of the cache 325 by mitigating any need to decompress or decrypt data in the cache 325. In other embodiments, the cache 325 stores compressed and/or encrypted data, thus increasing the cache's capacity and/or security.

The cache 325 often operates in a full or nearly full state. Once the cache 325 has filled up, the removal of data from the cache 325 is handled according to one or more selected cache maintenance policies, which can be applied at the volume and/or file level. These policies may be preconfigured, or chosen by an administrator. One policy that may be used, for example, is to remove the least recently used data from the cache 325. Another policy that may be used is to remove data after it has resided in the cache 325 for a predetermined amount of time. Other cache maintenance policies may also be used.

The cache 325 stores both clean data (data that has been written to the storage cloud) and dirty data (data that has not yet been written to the storage cloud). In one embodiment, different cache maintenance policies are applied to the dirty data and to the clean data. An administrator can select policies for how long dirty data is permitted to reside in the cache 325 before it is written out to the storage cloud. Too short of an interval will waste bandwidth between the user agent 310 and the storage cloud by moving data that will shortly be discarded or superseded. Too long of an interval creates potential data retention issues. Similarly, there are policies about how long non-dirty data ought to be retained in the cache. In an example, a least recently used policy may be used for the clean data, and a time limit policy may be used for the dirty data. Regardless of the cache maintenance policy or policies used for the dirty data, before dirty data is removed from the cache 325, the dirty data is written to the storage cloud.

Compressor 320 compresses data 315 received from client 305 when client 305 attempts to store the data 315. The term compression as used herein incorporates deduplication. The compression schemes used in one embodiment automatically achieve deduplication. In one embodiment, compressor 320 compresses the data 315 by comparing some or all of the data 315 to data objects stored in the cache 325. Where a match is found between a portion of the data 315 and a portion of a data object stored in the cache 325, the matching portion of data is replaced by a reference to the matching portion of the data object in the cache 325 to generate a new compressed data object. Thus, such a compressed data object includes a series of raw data strings (for unmatched portions of the data 315) and references to stored data (for matched portions of the data 315). In one embodiment, at the beginning of each string of raw data is a pointer to where in the sequence a particular piece of data from a referenced data object should be inserted.

Once this transformation is completed (i.e., the replacement of matched strings with references to those matched strings and the framing of the non-matched data), the resulting data can optionally be run through a conventional compression algorithm like ZIP, BZIP2, Lempel-Ziv-Markov chain algorithm (LZMA), Lempel-Ziv-Oberhumer (LZO), compress, etc.

In another embodiment, the compressor 320 compresses the data object 315 by replacing portions of the data object with hashes of those portions. Other compression schemes are also possible.

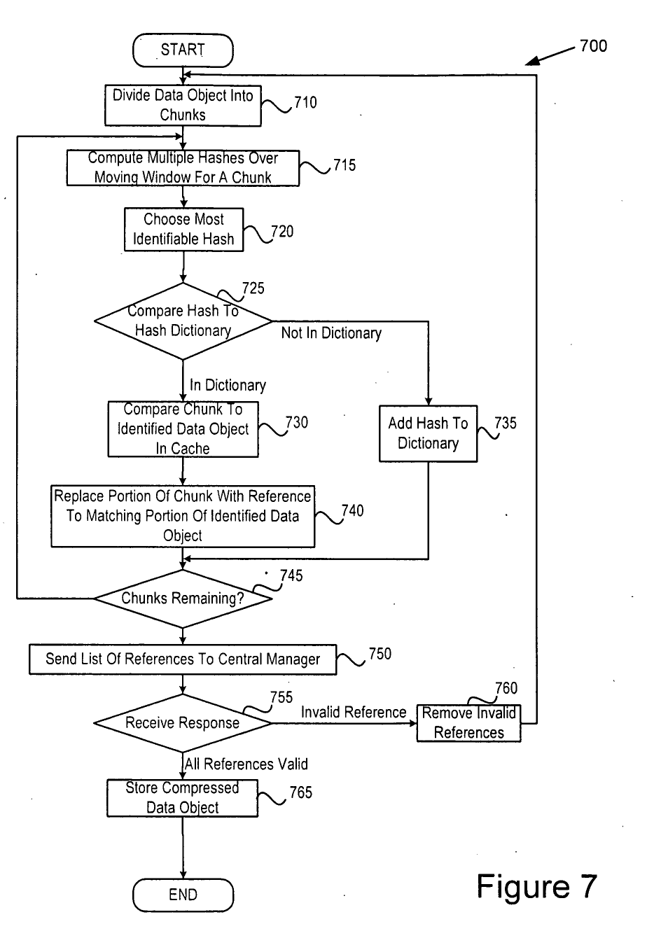

In one embodiment, compressor 320 maintains a temporary hash dictionary 330. The temporary hash dictionary 330 is a table of hashes used for searching the cache 325. The temporary hash dictionary 330 includes multiple entries, each entry including a hash of data in the cache 325 and a pointer to a location in the cache 325 where the data associated with that hash can be found. Therefore, in one embodiment, the compressor 320 generates multiple new hashes of the portions of the data object 315, and compares those new hashes to temporary hash table 330. When matches are found between the new hashes of the data object 315 and hashes associated with portions of a data object in the cache 325, the cached data object from which the hash was generated can be compared to the portion of the data object 315 from which the new hash was generated. Compression is discussed in greater detail below with reference to FIG. 7.

It should be noted that the temporary hash dictionary is used only to search for matches during compression, and is not necessary for decompressing data objects. Therefore, the contents of the hash dictionary are not critical to decompression. Thus, decompression can be performed even if the contents of the hash dictionary are erased.

Referring to FIG. 3, each user agent 310 may have a different subset of the data stored in the storage cloud in the cache 325. Therefore, in one embodiment, each user agent 310 essentially has a different dictionary (which is not synchronized with all of the data in the storage cloud) against which that agent 310 compresses data objects (e.g., files). However, each user agent 310 should be able to decompress the compressed data object 315 regardless of the contents of the user agent's cache 325. That means that if the compressed data object is essentially a set of references, these references should be obtainable and understandable to all user agents. In other words, the user agent 310 is capable of acquiring for its cache 225 all of the data that is being referenced in the compressed data object.

Accordingly, in one embodiment, all object names are globally coherent. Furthermore, the globally coherent name for each data object in one embodiment is a unique name. Therefore, a name of an object stored in the cache 325 is the same name for that object stored in the storage cloud and in any other cache of another user agent 310. Therefore, the reference to the stored data in the cache 325 is also a reference to that stored data in the storage cloud. This means that given a name for a data object, any user agent 310 can retrieve that data object from the storage cloud. As a consequence, since each compressed data object is a combination of raw data (for portions of the data object that did not match any data in cache 325) and references to stored data, any user agent reading the data object has enough data to decompress the data object. This is true whether the user agent that attempts to read the data object compressed it (which would likely still have the same cached data that was used to compress the data object) or a different user agent attempts to read the data object (which may not have the same cached data that was used to compress data object).

In one embodiment, the compressor 320 further compresses the compressed data object using zip or other another standard compression algorithm before the compressed data object is stored in the storage cloud.

In one embodiment, the compressed data object is encrypted by encrypter 335. Encrypter 335 in one embodiment encrypts both data that is at rest and data that is in transit. Encrypter 335 encrypts data sent to the storage cloud using a globally agreed upon set of keys. A globally agreed upon set of keys is used so that a compressed data object stored in the storage cloud that has been encrypted by one user agent can be decrypted by a different user agent. In one embodiment, the encrypter 335 caches the security keys in an ephemeral storage (e.g., volatile memory) such that if the user agent 310 is powered off, it has to reauthenticate to obtain the keys. In one embodiment, the security keys are stored in cache 325.

In one embodiment, standard cryptographic techniques are used to prevent security breaches such as known clear text attacks (i.e., the encryption is assaulted with the well known name of the data). For example, the encrypter 335 may encrypt compressed data objects using an encryption algorithm such as a block cipher. In one embodiment, a block cipher is used in a mode of operation such as cipher-block chaining, cipher feedback, output feedback, etc. In one embodiment, the encryption algorithm uses the globally coherent name of the data object being encrypted as salt for the block cipher. Salt is a non-confidential value that is added into the encryption process such that two different blocks that have the same cleartext value will yield two different cipher text outputs In one embodiment, the encrypter 335 may obtain the globally agreed upon set of keys to use for encrypting and decrypting compressed data objects from the central manager.

In one embodiment, encrypter 335 also encrypts data that resides in cache 325. In one embodiment encrypter 335 handles encryption and integrity of the data in flight using the standard HTTPS protocol.

Security between the clients 305 and the user agent 310 is handled via security mechanisms built into standard file system protocols (e.g., CIFS or NFS) that the clients 305 use to communicate with the user agent 310. For Example, in CIFS the user agent 310 and clients 305 are part of the same security envelope. Keys for use in transmissions between the clients 305 and the user agent 310 in this example would be negotiated and authenticated according to the CIFS standard, which may involve the use of an active directory server (a part of CIFS).

Authentication manager 345 in one embodiment handles two types of authentication. A first type of authentication involves authentication of clients to the user agent 310. In one embodiment, clients authenticate to the user agent 310 using authentication mechanisms built into the wire protocols (e.g., file system protocols) that the clients use to communicate with the user agent 310. For example, CIFS, NFS, iSCSI and fiber channel all have their own authentication schemes. In one embodiment, authentication manager 340 enforces and/or participates in these authentication schemes. For example, with CIFS, authentication manager 340 can enroll the user agent 310 into a specific domain, and query a domain controller to authenticate client systems and interpret CIFS access control lists.

A second type of authentication involves authentication of the user agent 310 to the central manager. In one embodiment, authentication of the user agent 310 to the central manager is handled using a certificate based scheme. The authentication manager 340 provides credentials to the central manager, and if the credentials are satisfactory, the user agent 310 is authenticated. Once authenticated, the user agent 310 is provided the security keys necessary to access data in the storage cloud.

In one embodiment, the user agent 310 includes a protocol optimizer 345 that performs optimizations on protocols used by the user agent 310. In one embodiment, the protocol optimizer 345 performs CIFS optimization in a manner well known in the art. For example, the protocol optimizer 345 may perform read ahead (since CIFS normally can only make a 64KB read at a time) and write back. In one embodiment, since the user agent 310 resides on the same local network as the clients 305 that it services, many common WAN optimization techniques are unnecessary. For example, in one embodiment the protocol optimizer 345 does not need to perform operation batching or TCP/IP optimization.

In one embodiment, the user agent 310 includes a user interface 350 through which a user can specify configuration properties of the user agent 310. The user interface 350 may be a graphical user interface or a command line interface. In one embodiment, an administrator can select the cache maintenance policies that control residency of data in the user agent's cache 325 via the user interface 350.

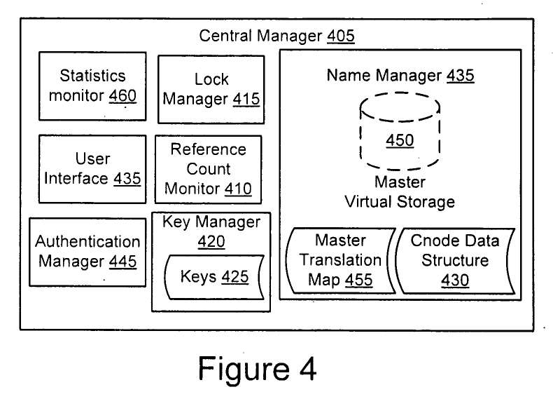

FIG. 4 illustrates a block diagram of a central manager 405. In one embodiment, the central manager 405 is located on a local network of an enterprise. In another embodiment, the central manager 405 is provided as a third party server (which may be a web server) that can be accessed from one or more enterprise locations. In one embodiment, the central manager 405 corresponds to central manager 110 of FIG. 1. The central manager 405 is responsible for ensuring coherency between different user agents. For example, the central manager 405 manages data object names, manages the mapping between virtual storage and physical storage, manages file locks, monitors reference counts, manages encryption keys, and so on. The central manager 405 in one embodiment includes a lock manager 415, a reference count monitor 410, a name manager 435, a user interface 435 and a key manager 420 that manages one or more encryption keys 425. In other embodiments, central manager 405 includes a subset of these components.

The lock manager 415 ensures synchronized access by multiple different user agents to data stored within the storage cloud. Lock manager 415 allows multiple disparate user agents to have synchronized access to the same data by passing metadata traffic (locks) that allow one user agent to cache data objects speculatively. Locks restrict access to data objects and/or restrict operations that can be performed on data objects. The lock manager 415 may perform numerous different types of locks. Examples of locks that may be implemented include null locks (indicates interest in a resource, but does not prevent other processes from locking it), concurrent read locks (allows other processes to read the resource, but prevents others from having exclusive access to it or modifying it), concurrent write locks (indicates a desire to read and update the resource, but also allows other processes to read or update the resource). protected read locks (commonly referred to as shared locks, wherein others can read, but not update, the resource), protected write locks (commonly referred to as update locks, wherein indicates a desire to read and update the resource and prevents others from updating it, and exclusive locks (allows read and update access to the resource, and prevents others from having any access to it).

In one embodiment, the lock manager 415 provides opportunistic locks (oplocks) that allow a file to be locked in such a manner that the locks can be revoked. The oplocks allow file data caching on a user agent to occur safely. When a user agent opens a file, it may request an oplock on the file. If the oplock is granted, the user agent may safely cache the file. If a second user agent then requests the file, the oplock can be revoked from the first user agent, which causes the first user agent to write any changes to the cached data for the file. The central manager then responds to the open from the second user agent by granting an oplock to that user agent. If the file included any modifications, those modifications can be written to the storage cloud, and the second user agent can open the file with the modifications. The first user agent can also have the opportunity to write back data and acquire record locks before the second user agent is allowed to examine the file. Therefore, the first user agent can turn the oplock into a full lock.

In one embodiment, data is stored in a hierarchical framework, in which the top of the hierarchy includes data that reference other data, but which is not itself referenced, and the bottom of the hierarchy includes data that is referenced by other data but does not itself reference other data. In one embodiment, oplocks are granted for hierarchies. The lock manager 415 grants oplocks for the highest point in the hierarchy possible. For example, if a user agent requests to read a file, it may first be granted an oplock for a directory that includes the file. The oplock includes locks for the requested file and all other files in the directory. If another user agent requests to read a different file in the directory, the oplock to the directory is revoked, and the first user agent is then given an oplock to just the file that it originally requested to read. If another user agent then attempts to read a different portion of the file than is being read by the first user agent, and the file is divided into multiple data objects, then the oplock for the file may be revoked, and an oplock for those data objects that are being read exclusively by the first user agent may be granted to that user agent. In one embodiment, the smallest unit to which an oplock may be granted would be a data object in the storage cloud.

The lock manager 415 determines what locks to use in a given situation based on the circumstances. If, for example, requested data is not already locked, then a lock is granted to the requesting user agent together with the latest version information. If the requested data is already locked, then the lock manager 415 determines if the lock is permitted to be broken (e.g., if it is an oplock). If the lock cannot be broken, then the user agent is informed that the file is locked and unavailable. If the lock can be broken, the lock manager 415 informs the user agent that has the existing lock that the lock is being broken, requesting it to flush any modifications to the data out to the storage cloud and provide the central manager 405 with the name of the new version of the data. Once this is done, the central manager 405 informs the requesting user agent of the location of the data in the storage cloud. As an optimization, the user agent could forward the data directly to the requesting user agent or indirectly through the central manager 405 (while optionally also writing it to the cloud).

The lock manager 415 enables the user agents to have caches that locally store globally coherent data. The user agents can interrogate the lock manager 415 to get the latest version of a data object, and be sure that they have the latest version while they work on it based on locks provided by the lock manager 415. In one embodiment, once a lock is granted to a user agent for a client, that lock is maintained until another user agent asks for the lock. Therefore, the lock may be maintained until someone else needs the lock, even if the user agent hadn't been using the file.

The lock manager 415 guarantees that whenever a client attempts to open a file, it will always get the latest version of that file, even though the latest version of the file might be cached at another user agent, and not yet written to the storage cloud. In one embodiment, all the user agent attempting to open the file needs is the unique name and location of the file. This can be obtained directly from another user agent (out of band) or from the central manager (in band). For example, one user agent can write a file, get data back, and send a message to another user agent identifying where the file is and to go get it.

In CIFS, whenever a lock is lost, the cache is flushed (data is removed from the cache) regarding the file for which the lock was lost. If the user agent wants to open the file again, in CIFS it needs to reacquire the data from storage. However, often after the lock is given up no other changes are made to the file. Therefore, in one embodiment, the lock manager does not force user agents to flush the cache when a lock is given up. In a further embodiment, the cache is not flushed even if another user agent obtains a lock (e.g., an exclusive lock) to the data. If a user agent caches a file, and is forced to give up a lock for the cached file, it retains the file in the cache. In one embodiment, a client of the user agent attempts to open the file, the user agent determines whether the file has been changed, and if it has not been changed, then the cached data is used without re-obtaining the data. This can provide a significant improvement over the standard CIFS file system.

In one embodiment, the name manager 435 keeps track of the name of the latest version of all data objects stored in the storage cloud, and reports this information to the lock manager 415. In one embodiment, this data can be provided by the lock manager 415 to user agents in only a few bytes and a single network round trip. For example, a user agent sends a message to the central manager 405 indicating that a client has requested to open file A. The name manager 435 determines that the name of the data object associated with the latest version for file A is, for example, 12345, and the lock manager 415 notifies the user agent of this.

In one embodiment, name manager 435 includes a compressed node (Cnode) data structure 430, a master translation map 455 and a master virtual storage 450. In one embodiment, names of data objects associated with the most recent versions of data are maintained in a master translation map 455. In one embodiment, the master translation map 455 maps client viewable data to compressed data objects and/or compressed nodes (Cnodes) that represent the compressed data objects.

In one embodiment, name manager 435 maintains a Cnode data structure 430 that includes a distinct Cnode for each data object. The data object referenced by each Cnode is immutable, and therefore the Cnode will always correctly point to the latest version of a data object. The Cnode represents the authoritative version of the data object. In one embodiment, in which rewrites are not permitted because the storage cloud does not provide clean re-write semantics, once a user agent has cached data, that data remains accurate unless it corresponds to a data object that has been deleted from the storage cloud. This is because in one embodiment the data will never be replaced since there are no rewrites. It is up to the central manager 405 never to hand out a reference (e.g., a Cnode including a reference) that is invalid. This can be guaranteed using reference counts, which are described below with reference to reference count monitor 410.

In one embodiment, the Cnode includes all of the information necessary to locate/read the data object. The Cnode may include a url text, or an integer that gets converted into a url text by a known algorithm. How the integer gets converted, in one embodiment, is based on a naming convention used by the storage cloud. The Cnode is similar to an inode in a typical file system. Like an inode, the Cnode can include a pointer or a list of pointers to storage locations where a data object can be found. However, an inode includes a list of extents, each of which references a fixed size block. In a typical file system, the client gets back a fixed number of bytes for any address. Therefore, in a typical file system, an object that a client receives can only store a finite amount of data. So if a client requests to read a large file, it will be given an object that points to other objects that point to the data. In conventional file systems, if more bytes are needed, another address must be provided. In contrast, in cloud storage, a reference (address) is provided that can point to a 1 byte object or a 1 GB object, for example. Therefore, the pointers in the Cnode may point to an arbitrarily sized object. Thus, a Cnode may include only a single pointer to an entire file (e.g., if the file is uncompressed), a dense map of pointers to multiple data objects, or something in between.

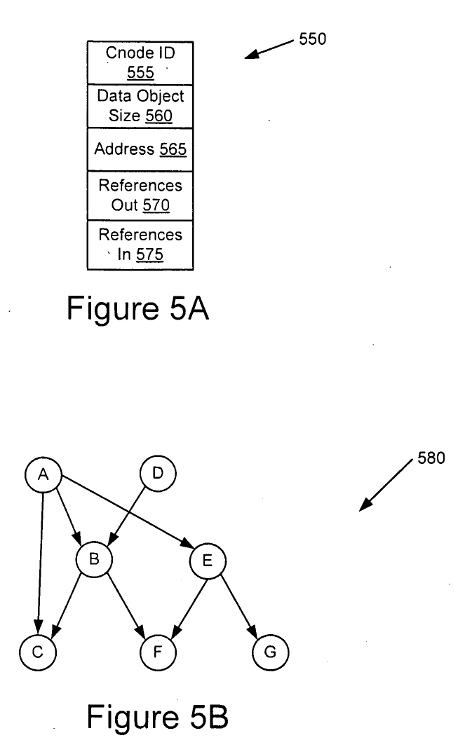

FIG. 5A illustrates a Cnode 550, in accordance with one embodiment of the present invention. In one embodiment, the Cnode 550 includes a Cnode identifier (ID) 555, a data object size 560, a data object address 565, a list of other data objects that are referenced by the Cnode 550 (references out 570), and a count of the number of references that are made to the data object represented by the Cnode 550 (references in 575). The Cnode ID 555 is a unique global name for the Cnode 550. The data object size 560 identifies the size of the data object referenced by the Cnode 550. The address 565 includes the data necessary to retrieve the data object from storage (e.g., from the storage cloud or from a user agent's cache). The address 565 may be, for example, a url text, an integer that gets converted into a url text, and so on. In one embodiment, the Cnode 550 includes a list of each of the data objects that are referenced by the data object represented by the Cnode 550 (references out 570). For example, if the Cnode 550 is for a compressed data object that includes references to three different additional compressed data objects, then the references out would include an identification of each of those additional compressed data objects. In one embodiment, the Cnode 550 includes a reference count of the number of references that are made to the object represented by the Cnode 550 (references in 575).

The illustrated Cnode 550 contains a list of the other Cnodes that are referenced by this Cnode 550 (references out 570), but does not include the actual information used to fully reconstruct the data object represented by the Cnode 550. Instead, in one embodiment, such information is stored in the storage cloud itself, thus minimizing the amount of local storage in the user agents and/or central manager required for the Cnode 550. In such an embodiment, the data object itself includes the information necessary to locate particular additional data objects referenced by the data object (e.g., offset and length information). The Cnode 550 only identifies which data objects are being referenced (not the specific locations within the data objects that are being referenced).

In another embodiment, the Cnode 550 includes the data necessary to reconstruct the data object represented by the Cnode 550. In one embodiment, the Cnode 550 includes a file name, an offset into the file and a length for each of the data objects referenced by the Cnode 550. Such Cnodes occupy additional space in the user agents and central manager, but enable all data objects directly referenced by a particular data object to be retrieved without first retrieving that particular data object.

Referring back to FIG. 4, reference Count Monitor 410 keeps track of how many times each portion of data stored in the storage cloud has been referenced by monitoring reference counts. A reference count is a count of the number of times that a data object has been referenced. The reference count for a particular data object includes both address references and compression references. The address references and compression references are semantically different. The address references are references made by a protocol visible reference tag (a reference that is generated because a file protocol can construct an address that will eventually require this piece of data). The address reference includes address information, and in one embodiment is essentially metadata that comes from the structure of how data in the virtual storage is addressed. It is data independent, but is dependent on the structure of the virtual storage (e.g., whether it is a virtual block device or virtual file system).

The compression references are references generated during generation of compressed data objects. The compression references are generated from data content.

Every time a new data object references another data object (including a reference to a portion of the other data object), the reference count for that referenced data object is incremented. Every time a data object that references another data object is deleted, the reference count for that referenced data object is decremented. Similarly, whenever the master translation map is updated to include a new address reference to a data object, the reference count for that data object is incremented, and whenever an entry is removed from the master translation map, the reference count of an associated data object is decremented. When the reference count for a data object is reduced to zero (or some other predetermined value), that means that the data object is no longer being used by any data object or client viewable data (e.g., a name for a file or block in a virtual storage), and the data object may be deleted from the storage cloud. This ensures that data objects are only removed from the storage cloud when they are no longer used, and are thus safe to delete.

The reference count monitor 410 ensures that data objects are not deleted from the storage cloud unless all references to that data have been removed. For example, if a reference points to another block of data somewhere in the storage cloud, the reference count monitor 410 prevents that referenced block of data from being deleted even if a command is given to delete a file that originally mapped to that data object.

In one embodiment, references include sub-data object reference information, identifying particular portions of data objects that are referenced. Therefore, if only a portion of a data object is referenced, the remaining portions of the data object can be deleted while leaving referenced portion.

It should be noted that references can be recursive. Therefore, a single data object may be represented as a chain of references. In one embodiment, the references form a directed acyclic graph.

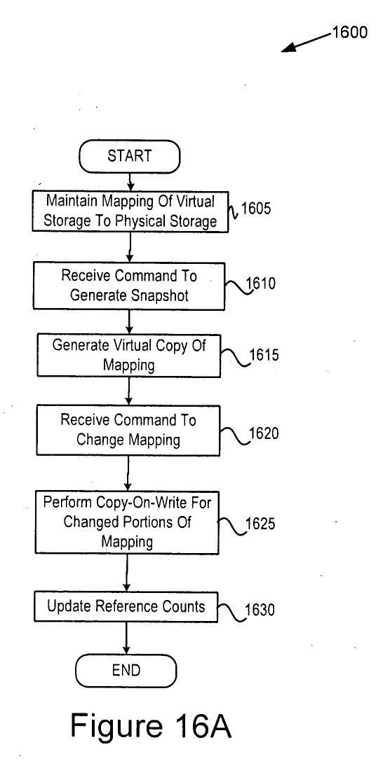

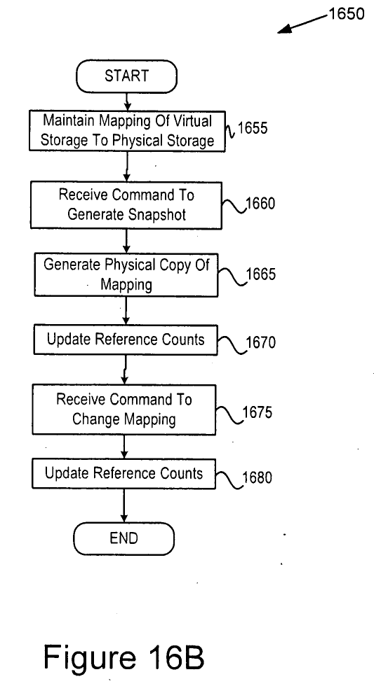

In one embodiment, reference count monitor 410 generates point-in-time copies (e.g., snapshots) of the master virtual storage 450 by generating copies of the master translation map 455. The copies may be virtual copies or physical copies, in whole or in part. The reference count monitor 410 may generate snapshots according to a snapshot policy. The snapshot policy may cause snapshots to be generated every hour, every day, whenever a predetermined amount of changes are made to the master virtual storage 450, etc. The reference count monitor 410 may also generate snapshots upon receiving a snapshot command from an administrator. Snapshots are discussed in greater detail below with reference to FIGS. 16A-16B.

FIG. 5B illustrates an exemplary directed acyclic graph 580 representing the reference counts for data stored in a storage cloud, in accordance with one embodiment of the present invention. In the directed acyclic graph 580, each vertex (node) represents a data object, and each edge represents a reference to another data object. The data object represented by a vertex may be an entire data object (e.g., a file), a portion of a data object, a reference to one or more data objects, or a combination thereof. Each vertex may be variably sized, ranging from a few bytes to gigabytes. In one embodiment, data objects have a maximum size of about 1 MB.

Returning to FIG. 4, when a user agent attempts to compress a data object, it sends a list of the references to the central manager 405. In one embodiment, the list of references include those references that the user agent proposes to use for the compression. The reference count monitor 310 compares the list of references to the current reference count. Any reference in the list that does not have a reference count (or has a reference count of 0) may have been deleted from the storage server, and is an invalid reference. This means that the cached copy at the user agent is out of date, and includes data that may have been deleted. In such an occurrence, the central manager 405 sends back a message to the user agent identifying those references that are invalid. If all of the references in the reference list are valid, then the reference count monitor 410 may increment the reference count for each of the references included in the list. This embodiment performs local deduplication based on caches of individual user agents.

Key manager 420 manages the keys 425 that are used to encrypt and decrypt data stored in the storage cloud. In one embodiment, after data is compressed, the data is encrypted with a key provided by key manager 420. When the data is later read, the key used to encrypt the data is retrieved by the key manager 420 and provided to a requesting user agent. The encryption mechanism is designed to protect the data in transit to and from the storage cloud and the data at rest in the storage cloud.

In one embodiment, central manager 405 includes an authentication manager 445 that manages authentication of user agents to the central manager 405. The user agents communicate with the central manager in order to obtain the encryption keys for the data in the storage cloud. The user agents authenticate themselves to the central manager before they are given the keys. In one embodiment, standard certificate-based schemes are used for this authentication.

In one embodiment, the central manager 405 includes a statistics monitor 460 that collects statistics from the user agents. Such statistics may include, for example, percentage of data access requests that are satisfied from user agent caches vs. data access requests that require that data be retrieved from the storage cloud, data access times, performance of data access transactions, etc. The statistics monitor 460 in one embodiment compares this information to a service level agreement (SLA) and alerts an administrator when the SLA is violated.

In one embodiment, the central manager 405 includes a user interface 435 through which an administrator can change a configuration of the central manager 410 and/or user agents. The user interface can also provide information on the collected statistics maintained by the statistics monitor 460.

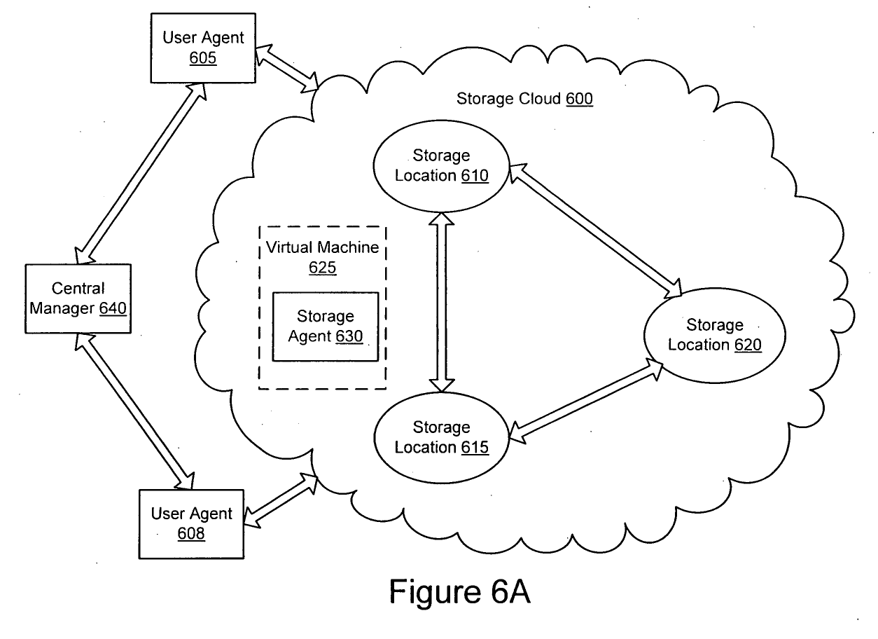

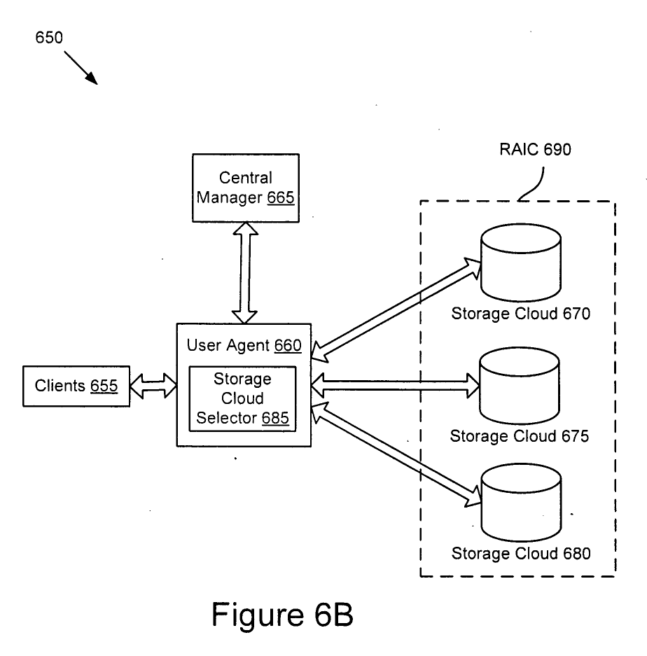

FIG. 6A illustrates a storage cloud 600, in accordance with one embodiment of the present invention. The storage cloud 600 in one embodiment corresponds to storage cloud 115 of FIG. 1. Storage cloud 600 may be Amazon's S3 storage cloud, Nirvanix's SDN storage cloud, Mosso's Cloud Files storage cloud, etc.

User agents (e.g., user agent 605 and user agent 608) perform read and write operations to the storage cloud 600 using, for example, HTTP, REST and/or SOAP commands. Conventional cloud storage uses HTTP and/or SOAP. Such HTTP based storage provides storage locations as universal resource locators (urls), which can be accessed, for example, using HTTP get and post commands. However, there are significant differences between the storage clouds provided by different providers. For example, different storage clouds may handle objects differently. For example, Amazon's S3 storage cloud stores data as arbitrarily sized objects up to 5 GB in size, each of which may be accompanied by up to 2 kilobytes of metadata, where objects are organized in buckets, each of which is identified by a unique bucket ID, and each of which may be opened by a user-assigned key. Buckets and objects can be accessed using HTTP URLs. Nirvanix's SDN storage cloud, on the other hand requires that a client first access a name server to determine a location of desired data, and then access the data using the provided location. Moreover, each storage cloud includes its own proprietary application programming interfaces (APIs). For example, though Amazon's S3 and Nirvanix's SDN both operate using HTTP, they each operate using separate proprietary API's. Therefore, the specific contents of the commands used to retrieve or store data in the storage cloud 600 depends on the API provided by the storage cloud 600.

The storage cloud 600 includes multiple storage locations, such as storage location 610, storage location 615 and storage location 620. These storage locations may be in separate power domains, separate network domains, separate geographic locations, etc.

When transactions come in to the storage cloud 600 they get distributed. Such distribution may be based on geographic location (e.g., a user agent may be routed to a storage location that shared a geographic location with the user agent), load balancing, etc. When data is written to the storage cloud, it is written to one of the storage locations. Storage cloud 600 includes built in redundancy with replication of data objects. Therefore, the storage cloud 600 will eventually replicate the stored data to other storage locations. However, there is a lag between when the data is written to one location and when it is replicated to the other locations. Therefore, when viewed through a url, the data is not coherent. For example, if user agent 605 performs a put operation at storage location 610, and user agent 608 performs a get operation at storage location 615, user agent 608 may not get the latest version of the file that was just saved at storage location 610, because replication has not happened yet. Therefore, without proper safeguards, user agent 608 would be given an old version of the file. Central manager 640 provides such safeguards.

Because of the time lag between when data is written to one storage location, and when it is replicated to other storage locations, the central manager 110 of FIG. 1 assigns a separate unique name to each version of a data object. In one embodiment, user agents 605, 608 request the unique name of the most recent version of a data object from the central manager 640 each time the data object is accessed. Alternatively, the central manager 640 may send updates for all new versions of data objects whenever the new versions are written to the storage cloud. In either case, there will be no confusion as to whether a particular version of a file that a user agent obtains is the latest version.

In an example, user agent 605 writes a new version of a file to storage location 610. The central manager 640 previously assigned an original name to the first version of the file, and now assigns a new name to the second version of the file. When user agent 608 attempts to access the file, it contacts the central manager 640, and the central manager 640 notifies user agent 608 to access the file using the new name. The storage cloud 600 routes user agent 608 to storage location 615. However, since the second version of the file has not yet been replicated to storage location 615, the storage cloud 600 returns an error. User agent 608 can wait a predetermined time period, and then try to read the second version of the file again. By now, the second version of the file has been replicated to storage location 615, and user agent 608 reads the latest version of the file. This prevents the wrong data from being mistakenly accessed.

Continuing to refer to FIG. 6A, in one embodiment the storage cloud 600 includes a virtual machine 625 that hosts a storage agent 630. The storage agent 630 in one embodiment receives data access requests directed to the storage cloud 600. The storage agent 630 retrieves the requested data object from the storage cloud 600. The storage agent 630 reads the retrieved data object and retrieves additional data objects (or portions of additional data objects) referenced by the retrieved data object. This process continues for each of the retrieved data objects until all referenced data objects have been retrieved. The storage agent 630 then returns the requested data object and the additional data objects and/or portions of additional data objects to the user agent from which the original request was received.

One disadvantage of the storage agent 630 is that an enterprise may have to pay the provider of the storage cloud 600 for operating the storage agent 630, regardless of how much data is read from or written to the storage cloud 600. Therefore, cost savings may be achieved when no storage agent 630 is present.

Though the above description has been made with reference to a single storage cloud, in one embodiment multiple different storage clouds are be used in parallel. FIG. 6B illustrates an exemplary network architecture 650 in which multiple storage clouds are utilized, in accordance with one embodiment of the present invention.

The network architecture 650 includes one or more clients 655 and a central manager 665 connected with one or more user agent 660. The user agent is further networked with storage cloud 670, storage cloud 675 and storage cloud 680. These storage clouds are conceptually arranged as a redundant array of independent clouds 690.

The user agent 660 includes a storage cloud selector 685 that determines which cloud individual portions of data should be stored on. The storage cloud selector 685 operates to divide and replicate data among the multiple clouds. In one embodiment, the storage cloud selector 685 treats each storage cloud as an independent disk, and may apply standard redundant array of inexpensive disks (RAID) modes. For example, storage cloud selector 685 may operate in a RAID 0 mode, in which data is striped across multiple storage clouds, or in a RAID 1 mode, in which data is mirrored across multiple storage clouds, or in other RAID modes.

Each storage cloud provider uses a different cost structure for charging customers for use of the storage cloud. Typically, cloud storage providers charge a fixed amount per GB of storage used, a fixed amount per I/O operation, and/or additional fees. In one embodiment, the storage cloud selector 685 performs cost structure balancing, and decides which cloud to store data in based on an anticipated cost of the storage. The storage cloud selector 685 may take into consideration, for example, a predicted frequency with which the file will be accessed, the size of the file, etc. Based on the predicted attributes of the data, storage cloud selector 685 can determine which storage cloud would likely be a least expensive storage cloud on which to store the data, and place the data accordingly. For example, if a cloud storage has very low per GB storage fees but higher I/O fees, the storage cloud selector 685 would place data that will not be accessed frequently on that storage cloud, but may place data that would be accessed frequently on another storage cloud. This could be at least partially based on file type (e.g., email, document, etc.).

In one embodiment, storage cloud selector 685 migrates data between storage clouds based on predetermined criteria.

### II. Cloud Storage Optimized File System

Embodiments of the present invention provide a cloud storage optimized file system (CSOFS) that can be used for storing data over the network architectures of FIGS. 1-2. The cloud storage optimized file system (CSOFS) enables the user agents 105, 107 and central manager 110 to provide storage to clients 130 that includes the advantages of local network storage and the advantages of cloud storage, with few of the disadvantages of either. Note that though the CSOFS may be described with reference to files, the concepts presented herein apply equally to other data objects such as sub trees of a directory, blocks, etc.

As described above with reference to FIG. 6A, different user agents may access data from different locations within the storage cloud, and these locations may not always be synchronized (though in one embodiment they will always eventually synchronize). Therefore, to eliminate any ambiguity as to file versioning, in one embodiment the cloud storage optimized file system does not allow rewrite operations. Rather than writing over a previous version of a file using the same name (e.g., writing over portions of the file that have changed), a new copy of the file having a new unique name is created for each separate version of a file. If, for example, a user agent saves a file and immediately saves it again with a slightly different value, the new save is for a new file that is given a different unique name. The new version may thus be a separate file in the storage cloud.

The central manager knows which version of a data object a user agent needs, and identifies the name of that version to a requesting user agent. The central manager typically does not let a user agent open an older version of a file. If the new version is not available at the storage location to which a user agent is routed, then the user agent can simply wait for the file to replicate to that location.

When a new version of a file is written, the old version of the file can eventually be deleted, assuming that the old version is not included in a snapshot and is not referenced by other files. There is no requirement that the old version be deleted immediately upon the new version being written.

In one embodiment, the CSOFS includes instructions for handling both naming and locking. The CSOFS provides for an authoritative piece of information for data objects, and may speculatively grant a certain subset of privileges off of this. However, certain operations have to come back to the authoritative piece of information, which in one embodiment is maintained by the central manager. In one embodiment, the cloud storage optimized file system also does not permit write collisions. Therefore, multiple user agents may be prevented from writing the data object at the same time. Write collisions are prevented using locking.

In one embodiment, the file system has the properties of an encrypted file system, a compressed file system and a distributed shared file system. In other embodiments, the file system includes built in snapshot functionality and automatically translates between file system protocols and cloud storage protocols, as explained below. Other embodiments include some or all of these features.

FIG. 7 is a flow diagram illustrating one embodiment of a method 700 for generating a compressed data object. There are multiple compression schemes that may be used to generate the compressed data object. Method 700 describes generating compressed data objects using a reference compression scheme. In such a compression scheme, compression is achieved by replacing portions of a data object with references to previous occurrences of the same data. There are numerous searching techniques that may be used to compare portions of the data object to previously stored and/or compressed data. One such searching scheme is described in method 700, though other search schemes may also be used.

Though a reference compression scheme is described, other compression schemes, such as a hash compression scheme, may also be implemented. Using the hash compression scheme, a user agent breaks a data object up into multiple smaller chunks based on characteristics of the data object, and generates a hash for each chunk. This hash can then be compared to a dictionary of hashes, and replaced with a reference to a matching hash in the dictionary. A fundamental difference between the reference compression scheme and the hash compression scheme is that in the hash compression scheme, references are to data stored in the hash dictionary, and in the reference compression scheme, the references are to actual stored data. In the reference compression scheme no hash dictionary has to be maintained in order to be able to decompress data. In the hash compression scheme, on the other hand, data is physically split up into discrete objects, and a dictionary of those discrete objects is created.

Regardless of the compression scheme used, it is advantageous if all data is not required to go through a single point to achieve compression. Such a compression scheme could cause a bottleneck at the single point, and may cause scaling problems. For example, as the number of machines that use the file system increase, the slower the file system could become.

Method 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 700 is performed by a user agent 310 of FIG. 3. In one embodiment, method 700 is triggered when a user agent receives a write request from a client. The write request may be, for example, a request to store data to a virtual storage that is visible to the client via a standard file system protocol (e.g., NFS or CIFS).

Referring to FIG. 7, at block 710 of method 700 a user agent divides a data object (e.g., a piece of a file) to be compressed into smaller chunks. The data object may be divided into the smaller chunks on fixed or variable boundaries. In one embodiment, the boundaries on which the data object is divided are spaced as closely as can be afforded. The smaller the boundaries, the greater the compression achieved, but the slower compression becomes.

At block 715, the user agent computes multiple hashes (or other fingerprints) over a moving window of a predetermined size within a set boundary (within a chunk). In one embodiment, the moving window has a size of 32 or 64 bytes. In another embodiment, the generated hash (or other fingerprint) has a size of 32 or 64 bytes. It should be noted, though, that the size of the hash input is independent from the size of the hash output.

At block 720, the user agent selects a hash for the chunk. The chosen hash is used to represent the chunk to determine whether any portion of the chunk matches previously stored data objects (e.g., previously stored compressed data objects). The chosen hash is the hash that would be easiest to find again. Examples of such hashes include those that are arithmetically the largest or smallest, those that represent the largest or smallest value, those that have the most 1 bits or 0 bits, etc.

At block 725, the chosen fingerprint is compared to a hash dictionary (or other fingerprint dictionary) that is maintained by the user agent. The hash dictionary includes multiple entries, each of which include a hash and a pointer to a location in a cache where the data used to generate the hash is stored. The cache is maintained at the user agent, and in one embodiment includes cached clear text data of data objects that are stored in the storage cloud. In one embodiment, each entry in the hash dictionary includes a hash, a data object (e.g., a compressed data object) stored in the cache, and an offset into the data object where the data used to generate the matching hash resides. If the chosen hash is not in the hash dictionary, then the method proceeds to block 735. If the chosen hash is in the hash dictionary, the method continues to block 730.

At block 735, the hash is added to the hash dictionary with a pointer to the data that was used to generate the hash. Other insertion policies may also be applied. For example, the hash may be added to the hash dictionary before block 730 even if the hash was already in the hash dictionary. In another insertion policy, for example, every N hashes may be inserted.

It should be noted that the hash dictionary in one embodiment is used only for match searching, and not for actual compression. Therefore, the dictionary is not necessary for decompression. Thus, any user agent can decompress the compressed data regardless of the contents of the hash dictionary of that user agent. If the hash dictionary gets destroyed or is otherwise compromised, this just reduces the compression ratio until the dictionary is repopulated. In one embodiment, no maintenance of the hashes needs to be performed outside of the local user agent. Also, entries can simply be discarded from the dictionary when the dictionary fills up.

At block 730, the data in the referenced location is looked up and compared to the chunk. For example, a portion of a compressed data object stored in the cache may be compared to the chunk. The data that was used to generate the two hashes is a starting point for the matching. There is a good chance statistically that bytes in either direction of stored data that generated the stored hash will match surrounding bytes of the data that generated the chosen hash. Therefore, the bytes surrounding the matching data may be compared in addition to the matching data. If those bytes also match, then the next bytes are also compared. This continues until bits in the string of stored data fail to match bits in the data object to be compressed.

At block 740, the user agent replaces the matching portion of the data object, which can extend outside of the boundaries that were set for searching (e.g., outside of the chunk), with a reference to that same data in the cache. Since a global naming scheme is used, the references to the cached data are also references to the same data stored in the storage cloud.

At block 745, the user agent determines whether there are any additional chunks remaining to match to previously stored data. If there are additional chunks left, the method returns to block 715. If there are no additional chunks left, the method proceeds to block 750, and a list of the references used to compress the data object are sent to a central manager. In one embodiment, the list of references is included in a Cnode that the user agent generates for the compressed data object.

At block 755, the user agent receives a response from the central manager indicating whether or not the used references are valid. A reference may be invalid, for example, if the data object identified in the reference has been removed from the storage cloud but is still included in the user agent's cache. If the central manager indicates that all the references are valid (references are only to data that has not been deleted from the storage cloud), then the compression is correct, and the method proceeds to block 765. If the central manager indicates that one or more of the references are not valid, the method proceeds to block 760.

At block 760, the data objects that caused the invalid references are removed from the cache. The method then returns to block 710, and the compression is performed again with an updated cache.

At block 765, the compressed data object is stored. The compressed data object can be stored to the user agent's cache and/or to the storage cloud. If the compressed data object is initially stored only to the cache, it will eventually be written to the storage cloud.

The compressed data object includes both raw data (for the unmatched portions) and references (for the matched portions). In an example, if a user agent found matches for two portions of a data object, it would provide references for those two portions. The rest of the compressed data object would simply be the raw data. Therefore, an output might be 7 bytes of raw data, followed by reference to file 99 offset 5 for 66 bytes, followed by 127 bytes of clear data, followed by reference to file 1537 offset 47 for 900 bytes.

The method then ends.

Referring back to block 725, occasionally a single hash will have multiple hits on the cache. When multiple hits occur, the hits are resolved by choosing one of the hits with which to proceed (e.g., from which to generate a reference). The selection of which hit to use may be done in multiple different ways. One option is to use a first in first out (FIFO) technique to handle collisions. Alternatively, a largest match technique (e.g., most matching bits) may be used. In such a technique, the operations of block 730 may be performed for each of the hits, and a reference may be made to the data object that yields the largest match. Another option is to choose the hit based on a reference chain length. For example, a first compressed data object may reference a second compressed data object, which in turn may reference a third compressed data object. Alternatively, the first compressed data object may directly reference the third compressed data object. The second option may be chosen to avoid references to references to references, etc. which can cause the decompression process to stretch out arbitrarily long.

The above criteria for resolving multiple hits on the cache all apply to the selection of a single reference. There are also criteria that apply across the references. For example, the selection of which hits to use may be made to ensure that the number of unique data objects being referenced (NOT the number of references/matches themselves) is limited. This will also reduce the decompression process by putting an upper bound on the number of other data objects that are required to decompress this data object.

Because the references are generated using local data which is unsynchronized with the global (authoritative) copy, it's possible that the selected references are invalid (e.g., the message that would cause the invalidation has not yet arrived), implying that the references must be validated before proceeding. In the reference compression scheme, the compression may be an assumed accurate scheme (speculatively assume that the references are valid) or an assumed inaccurate scheme. In an assumed accurate scheme, as described above with reference to FIG. 7, the data object is compressed before sending any data to the central manager. This compression is a proposed compression. After a user agent has compressed the data, it sends the proposed compression to the central manager (e.g., the list of references). The central manager verifies whether the references in the compressed file are valid. If some aren't valid, then the central manager sends back a message indicating the references that are not valid. In response, the user agent deletes the data objects that caused the invalid references from its cache and then re-computes the compression without those data objects.

If the compression is an assumed inaccurate scheme (not shown), then the entire list of data objects stored in the user agent's cache is sent to the central manager before any compression occurs. The central manager then responds with a list of those data objects that no longer reside in the storage cloud. In response, the user agent removes those data objects, and then computes the compression. If the odds of a reference being invalid are low, then the assumed accurate reference compression scheme is more efficient. However, if the odds of a reference being invalid are high, then the assumed inaccurate reference compression scheme may be more efficient.

In one embodiment, whether the assumed accurate reference compression scheme or assumed inaccurate reference compression scheme is used, what goes out over the network is merely a reference (e.g., a pointer) to a previously stored string of data. Thus, the reference compression scheme causes a minimum of network traffic.

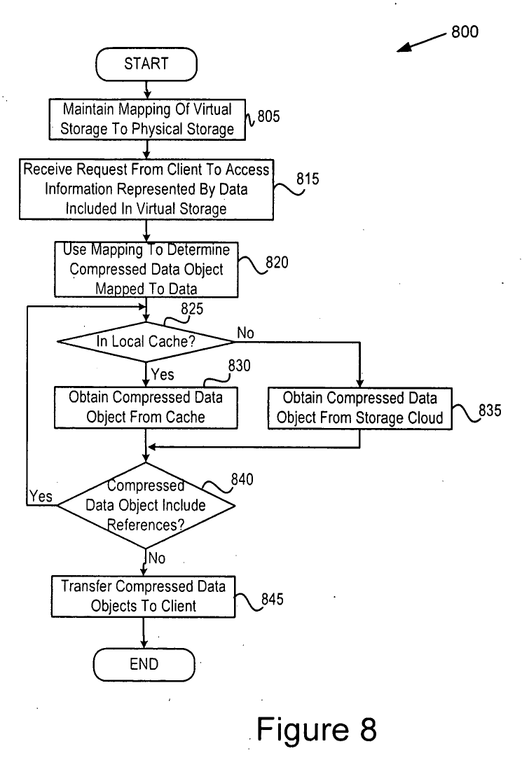

FIG. 8 is a flow diagram illustrating one embodiment of a method 800 for responding to a client read request. Method 800 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 800 is performed by a user agent 310 of FIG. 3 and/or central manager 405 of FIG. 4.

Referring to FIG. 8, at block 805 of method 800 a user agent and/or central manager maintains a mapping of a virtual storage to a physical storage. The virtual storage in one embodiment is a virtual file system or virtual block device that is accessible to clients via a standard file system protocol (e.g., NFS and CIFS). The physical storage is a combination of a local cache of a user agent and a storage cloud. The mapping includes address references from data included in the virtual storage (e.g., a block number of a virtual block device or file name of a virtual file system) to one or more compressed data objects included in the physical storage. In one embodiment, at least one of the one or more compressed data objects has been compressed at least in part by replacing portions of an uncompressed data object with compression references to matching portions of previously generated compressed data objects. Other compressed data objects may have been processed by a compression algorithm (e.g., using the reference compression scheme described above), but may not have achieved compression (e.g., if the compressed data object had no similarities to previously compressed data objects).

At block 815, a user agent receives a request from a client to access information represented by the data included in the virtual storage. At block 820, the user agent uses the mapping to determine one or more compressed data objects that are mapped to the data. In one embodiment, the user agent queries a central manager to determine a most current mapping of the data to the one or more compressed data objects.

At block 825, the user agent determines whether the compressed data object resides in a local cache. If the compressed data object does reside in the local cache, at block 830 the user agent obtains the compressed data object from the local cache. If the compressed data object does not reside in the local cache, at block 835 the user agent obtains the compressed data object from the storage cloud. The method then continues to block 840.

At block 840, the user agent determines whether the obtained compressed data object includes any references to other compressed data objects (which may include data objects that have been processed by a compression algorithm, but for which no compression was achieved). If the obtained compressed data object does reference other compressed data objects, then the method returns to block 825 for each of the referenced compressed data objects. If the compressed data object does not include any references to other compressed data objects, the method continues to block 845.

At block 845, the user agent decompresses the compressed data objects and transfers the information included in the compressed data objects to the client. The compressed data objects may include the compressed data object that was referenced by the data in the virtual storage as well as the additional compressed data objects referenced by that compressed data object, and any further compressed data objects referenced by the additional compressed data objects, and so on. In one embodiment, only information from those portions of the compressed data objects that are referenced is transferred to the client. The method then ends.

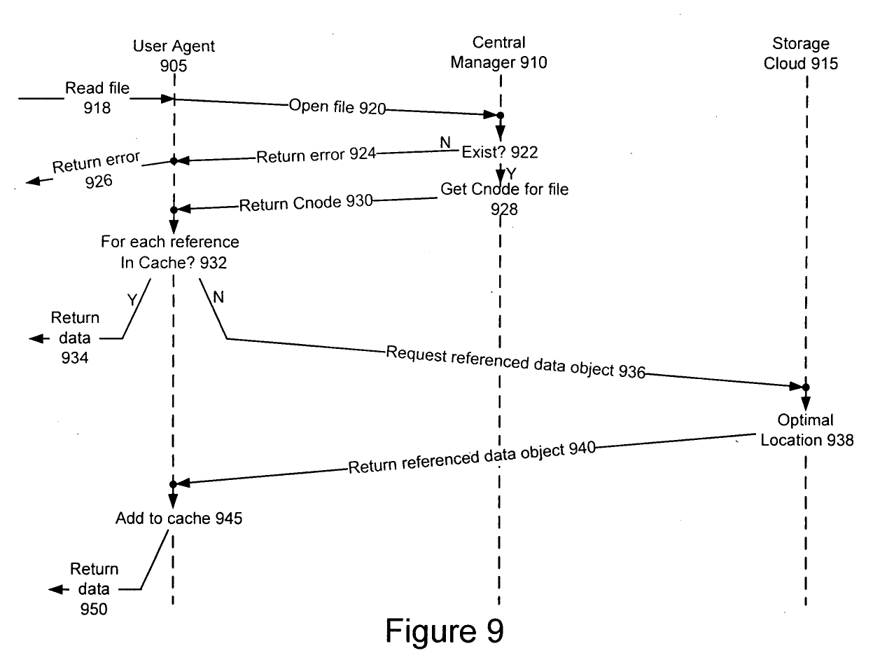

FIG. 9 illustrates a sequence diagram of one embodiment of a file read operation. The file read operation is performed when a client attempts to open a data object and read it. In one embodiment, the read operation is separated into a metadata portion and a data payload portion (involving actual file contents). The read operation is described with reference to a clear text reference compression scheme, but is equally applicable to a hash compression scheme or other compression schemes.

Referring to FIG. 9, upon a user agent 905 receiving a client request to open a file 918, user agent 905 sends an open file request 920 to the central manager 910. The central manager 910 then looks the file up in a translation map to determine whether the file exists 922 in the storage cloud 915. If the file does not exist, then the central manager 910 returns an error 924 to user agent 905. User agent 905 then sends the error 926 on to the requesting client. If the file does exist, and the requesting client has access to the file (e.g., based on an access control list) then the central manager 910 retrieves a compressed node (Cnode) 928 that uniquely identifies the file 915. The central manager 910 then returns the Cnode 930 to user agent 905.

In some cases there may be numerous versions of the requested file, each having a different Cnode. Typically, the central manager 910 returns the Cnode that corresponds to the most current version of the file. However, if the client was requesting to read a snapshot, then a Cnode to a previous version of the file may be returned.

Upon receiving the Cnode, user agent 905 finds the data corresponding to each pointer in the Cnode. For each pointer, user agent 905 first determines whether the referenced data is present in the local cache 932. If the data is in the local cache, then that chunk of data is returned to the client 934. If the data is not in the local cache, the user agent 905 requests the referenced data object 936 from the storage cloud 915.

The storage cloud 915 may include multiple copies of the referenced data object, each being located at a different location. On receiving a request for a data object, the storage cloud 915 routes the request to an optimal location. The optimal location may be based on proximity to the user agent 905, on load balancing, and/or on other considerations. The storage cloud then returns the referenced data object 940 from the optimal location. Note that in some instances the referenced data object may not yet be stored on the optimal location. In such an instance, the storage cloud 915 returns an error, and the user agent 905 sends another request for the referenced data object to the storage cloud 915. Since the location has been provided by the central manager 910 (from the Cnode), the user agent 905 is guaranteed that the location is correct. Therefore, the user agent 905 can be assured that eventually the referenced data object will be available at the optimal location.

The user agent 905 then adds the referenced data object to the user agent's cache 945. Data objects returned from the storage cloud 915 include one or both of clear text (raw data) and additional references. In one embodiment, only the clear text data is added to the cache. For each additional reference, the user agent 905 again determines whether the referenced data object is in the cache, and if it is not in the cache, it requests the data object from the storage cloud.

The portions of the data objects that together form the requested data can then be returned to the client. After some number of operations, all of the data is returned to the client. Typically, locality works, and that vast majority of what the client is looking for will be in the cache of his user agent.

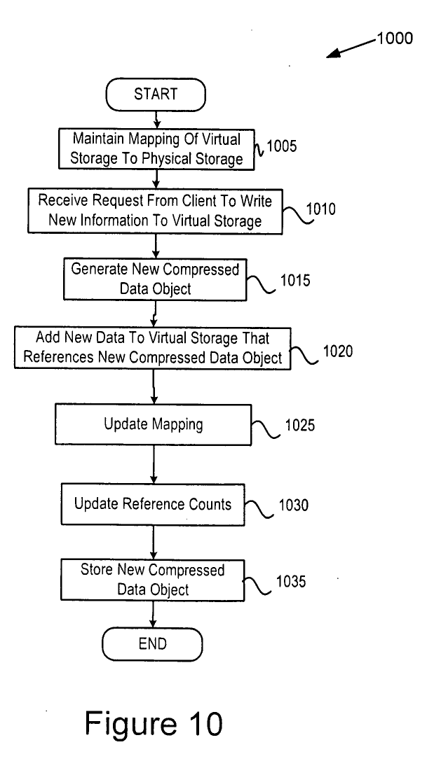

FIG. 10 is a flow diagram illustrating one embodiment of a method 1000 for responding to a client write request. Method 1000 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1000 is performed by a user agent 310 of FIG. 3 and/or central manager 405 of FIG. 4.

Referring to FIG. 10, at block 1005 of method 1000 a user agent and/or central manager maintains a mapping of a virtual storage to a physical storage. The virtual storage in one embodiment is a virtual file system or virtual block device that is accessible to clients via a standard file system protocol (e.g., NFS and CIFS). The physical storage is a combination of a local cache of a user agent and a storage cloud. The mapping includes address references from data included in the virtual storage to one or more compressed data objects included in the physical storage. In one embodiment, at least one of the one or more compressed data objects has been compressed at least in part by replacing portions of an uncompressed data object with compression references to matching portions of previously generated compressed data objects.

At block 1010, a user agent receives a request from a client to write new information to the virtual storage. At block 1015, the user agent generates a new compressed data object for the information. The new compressed data object in one embodiment is compressed as described above with reference to FIG. 7. Alternatively, the compressed data object may be compressed using, for example, a hash compression scheme.

At block 1020, the user agent adds new data (e.g., a new file name) to the virtual storage that references the new compressed data object via an address reference. At block 1025, the user agent updates the mapping to include the reference from the new data to the new compressed data object. The user agent may also report the new compressed data object, the new data and/or the new mapping to a central manager.

At block 1030, reference counts for compressed data objects referenced by the new data and/or by the new compressed data object are updated. Updating the reference counts can include incrementing those reference counts for compressed data objects that are pointed to by new compression references and/or new address references.

At block 1035, the new compressed data object is stored. The new compressed data object may be immediately stored in a storage cloud, or may initially be stored in a local cache and later flushed to the storage cloud. The method then ends.

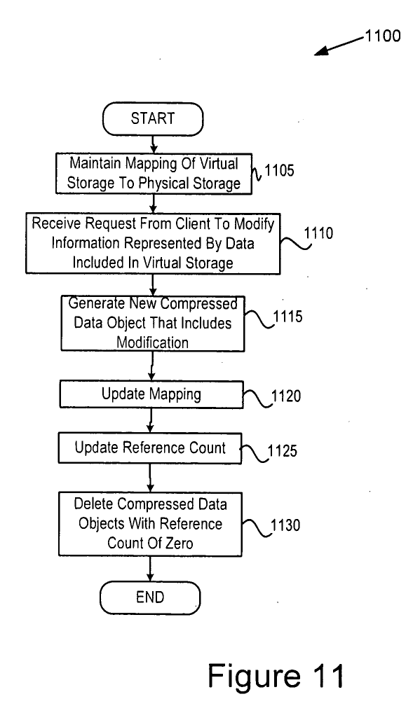

FIG. 11 is a flow diagram illustrating another embodiment of a method 1100 for responding to a client write request. Method 1100 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1100 is performed by a user agent 310 of FIG. 3 and/or central manager 405 of FIG. 4.

Referring to FIG. 11, at block 1105 of method 1100 a user agent and/or central manager maintains a mapping of a virtual storage to a physical storage. The virtual storage in one embodiment is a virtual file system or virtual block device that is accessible to clients via a standard file system protocol (e.g., NFS and CIFS). The physical storage is a combination of a local cache of a user agent and a storage cloud. The mapping includes address references from data included in the virtual storage to one or more compressed data objects included in the physical storage. In one embodiment, at least one of the one or more compressed data objects has been compressed at least in part by replacing portions of an uncompressed data object with compression references to matching portions of previously generated compressed data objects.

At block 1110, a user agent receives a request from a client to modify information represented by data included in the virtual storage. At block 1115, the user agent generates a new compressed data object that includes the modification. The new compressed data object in one embodiment is compressed as described above with reference to FIG. 7. Alternatively, the compressed data object may be compressed using, for example, a hash compression scheme.

At block 1120, the user agent updates the mapping to include a new address reference from the data to the new compressed data object. The user agent may also report the new compressed data object, the new data and/or the new mapping to a central manager.

At block 1125, reference counts for compressed data objects referenced by the new compressed data object are updated. Updating the reference counts can include incrementing those reference counts for compressed data objects that are pointed to by new compression references and/or new address references. If method 1100 is performed subsequent to generation of a point-in-time copy (e.g. a snapshot), then both a reference count for the new compressed data object and for at least one of the one or more compressed data objects previously referenced by the virtual data are incremented.

At block 1130, any compressed data objects with a reference count of zero are deleted. If, for example, a point-in-time copy of the virtual storage had been generated prior to execution of method 1100, then no compressed data objects would be deleted at block 1130. The method then ends.

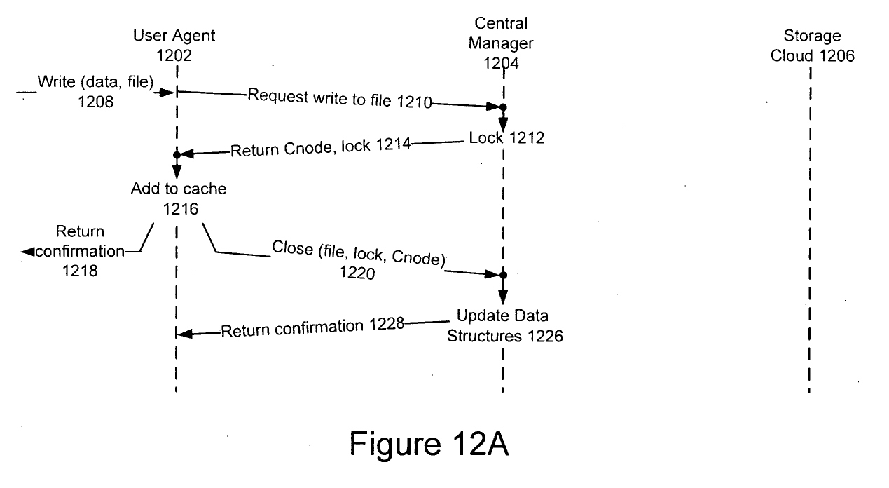

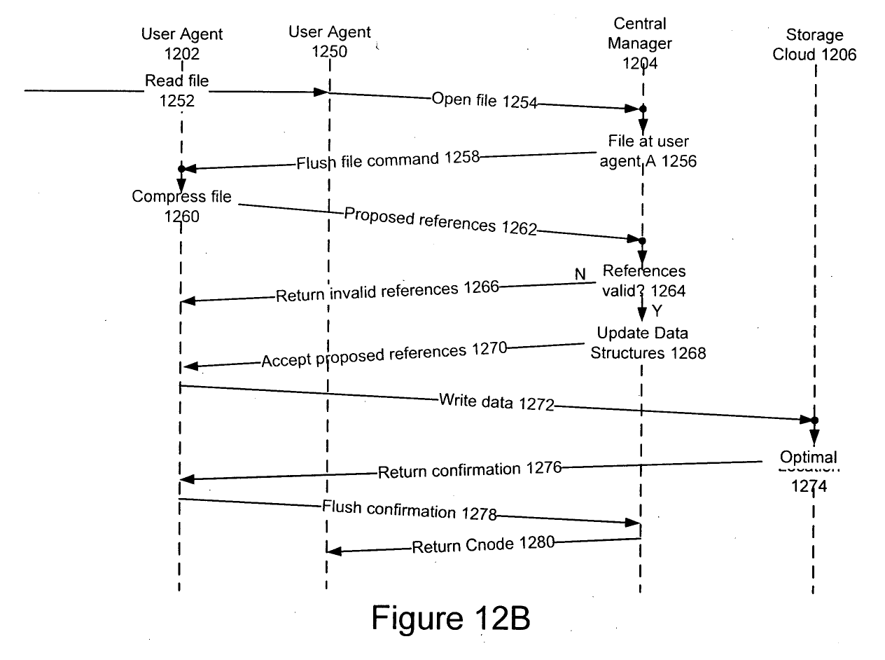

FIG. 12A is a sequence diagram of one embodiment of a write operation. The write operation may be an operation to write a new file or an operation to write a new version of an existing file to memory. In one embodiment, both operations are treated the same since rewrite operations are not permitted. As with the read operation, the write operation is divided into a metadata portion, that includes transmissions between the user agent and the central manager, and a data payload portion, that includes transmissions between the user agent and the storage cloud. The write operation is described with reference to a clear text reference compression scheme, but is equally applicable to a hash compression scheme or other compression schemes.

The write operation begins with user agent 1202 receiving a request to write data to a file 1208. User agent 1202 sends a write request 1210 to the central manager 1204 for the file. Provided that a non-revocable lock has not already been granted to another user agent for the file, the central manager 1204 generates a write lock 1212 for the file. The lock may be, for example, an exclusive lock and/or an oplock. The central manager 1204 may also provide a Cnode for the file. The central manager 1204 returns the Cnode along with the lock.

Upon receiving the lock and the Cnode, user agent 1202 can safely add the file to the cache 1216. User agent 1202 can then return confirmation that the write was successful 1218 to the client. User agent 1202 can also send a file close message 1220 to the central manager 1204. In one embodiment, the file close message includes the file lock, the name of the file and the Cnode.

The central manager 1204 then updates one or more data structures 1226 (e.g., the Cnode data structure, a data structure that tracks locks, etc.). The central manager 1204 then returns confirmation that the file close was received to user agent 1202.

In one embodiment, it is not necessary to send the file close message to the central manager 1204 immediately. If the user agent 1202 has sole write privilege (exclusive lock) for the file, for example, then it doesn't have to immediately send updates to the central manager 1204. In a shared write mode, new updates will stream back to the central manager 1204 as writes are made. In one embodiment, shared writes are permitted down to the granularity of a compressed data object. For example, two writes may be made concurrently to the same file that is mapped to multiple compressed data objects, so long as the writes are not to the same compressed data object.

At some time in the future, user agent 1202 receives a flush trigger. If user agent 1202 is operating in a write through cache environment, then the return confirmation is the flush trigger. However, if user agent 1202 is operating in a write back cache environment, the return confirmation may not be a flush trigger. Therefore, the update of the central manager 1204 is not necessarily synchronized to the spill of the data into the cloud (writing the file to the storage cloud). In the write back cache environment, when write data comes in it gets stored in the cache, and is not necessarily written through to the back end. Therefore, there may be extended lengths of time when authoritative data is out at a user agent. However, this is okay because the central manager 1204 knows that the authoritative data is at the user agent. Three possible triggers for flushing the data include: 1) the cache is full, 2) a threshold amount of time has passed since the cache was last flushed (e.g., administratively flush data for backup reasons after set time interval has elapsed), 3) another user agent (or client) has requested the file.

The read operation discussed below with reference to FIG. 12B illustrates the sequencing of one possible flush trigger.

FIG. 12B is a sequence diagram of one embodiment of a read operation, in which the authoritative data for the file being opened is at a user agent. The sequence begins with a client of user agent 1250 requesting to read a file 1255 that is in the control of user agent 1202. In response, user agent 1250 sends an open file request 1254 to the central manager 1204. The central manager 1204 determines that the authoritative version (latest version) of the file is stored at user agent 1256. The central manager 1204 then sends a flush file command 1258 to user agent 1202.

The flush file command corresponds to one of the flush triggers detailed with reference to FIG. 12A above. In response to receiving the flush file command, user agent 1202 in one embodiment compresses the file. Once the file is compressed, user agent 1202 generates a list of proposed references that are used in the compression, and sends this list of proposed references 1262 to the central manager 1204. User agent 1202 may keep track of what data in the file is dirty (what data is new data that has not been backed up to the cloud). This may affect the compression and/or may affect what references are sent to the central manager 1204. For example, user agent 1202 may know that all of the references to the non-dirty data are valid, and may only send those references that are used to compress the dirty portions of the data.

In another embodiment, user agent 1202 omits the reference matching (replacing portions of data with reference to previous occurrences of those portions) when the flush file command is received in order to decrease the amount of data required for the requesting user agent 1250 to decompress the data. If there are references that are misses in the cache of user agent 1250, then in some cases performance may actually decrease due to the compression (e.g., if references are used in compression that are not in user agent's 1250 cache, then user agent 1250 will have to obtain each of those references to decompress the file that was just compressed by user agent 1202). By foregoing replacement of portions of the data object with references to other data objects in this embodiment, the system avoids one or more round-trips to the central manager to validate the chosen references, and one or more round trips by the user agent 1250 to the storage cloud to obtain the referenced material.

The central manager 1204 then verifies whether the provided references are valid 1264. If any provided reference is invalid, then the central manager 1204 returns a list of the invalid references 1266. The user agent 1202 then removes the invalid references from its cache, recompresses the file, and sends the new references used in the latest compression to the central manager 1204. If all of the references are valid, the central manager 1204 updates its data structures 1268. This may include incrementing reference counts for each of the references used to compress the file, updating the Cnode data structure, etc. The central manager 1204 then returns confirmation that the file can be successfully written 1270 to user agent 1202. This confirmation includes an acceptance of the proposed references.

Upon receiving confirmation of the proposed compression, user agent 1202 writes the compressed data 1272 to the storage cloud 1206. The storage cloud 1206 determines the optimal location 1274 for the data, and permits the user agent 1202 to store the data there. The data will eventually be replicated to other locations within the storage cloud as well. The storage cloud 1206 may also send a return confirmation 1276 to user agent 1202 that the file was successfully stored.

Once the file has been stored to the storage cloud 1206, user agent 1202 sends a flush confirmation 1232 to the central manager. The central manager 1204 can then grant the file open request originally received from user agent 1250, and return the Cnode 730 for the file. The read operation may then commence as described above with reference to FIG. 9. In one embodiment, the user agent 1202 sends the flushed data to the requesting user agent 1250 either directly or via the central manager. This can eliminate a need for user agent 1250 to read the data back from the storage cloud.

Although the write operation described with reference to FIG. 12A and the read operation described with reference to FIG. 12B describe writing the data to the storage cloud 1206 after the proposed references are validated by the central manager 1204, the data may be written to the storage cloud 1206 before receiving such validation. In one embodiment, the data is pushed to the storage cloud 1206 in parallel to the proposed references being sent to the central manager 1204. The user agent 1202 can start sending the data, and abort the connection without finishing the sending of the data if confirmation of the validity of the references is not received before the write is completed.

How the connection is aborted may depend on the semantics of the storage cloud 1206 being written to. Some storage clouds, for example may accept partial transactions. Other storage clouds may not accept partial transactions. For those storage clouds that do not provide semantics for explicitly allowing the write transaction to be aborted, the user agent 1202 may modify the data to cause it to become invalid. For example, for transactions that are stamped with an MD5 hash for integrity, the transaction can be rendered invalid simply by changing one or more bits of the transmitted data. Therefore, as long as there is one bit left unsent, the transaction can be aborted.

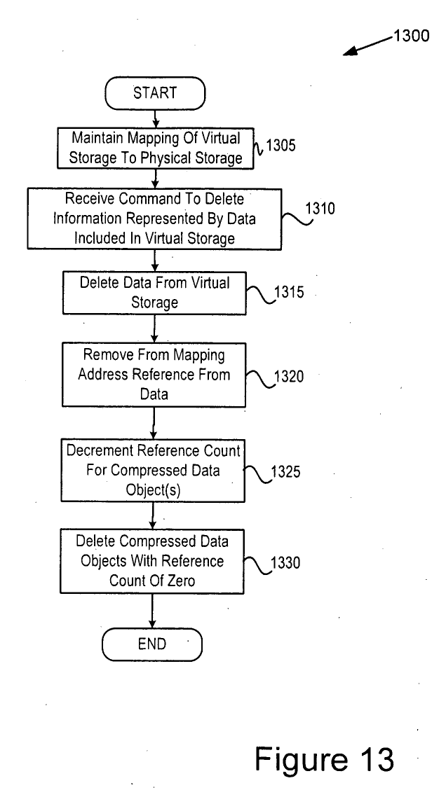

FIG. 13 is a flow diagram illustrating one embodiment of a method 1300 for responding to a client delete request. Method 1300 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1300 is performed by a user agent 310 of FIG. 3 and/or central manager 405 of FIG. 4.

Referring to FIG. 13, at block 1305 of method 1300 a user agent and/or central manager maintains a mapping of a virtual storage to a physical storage. The virtual storage in one embodiment is a virtual file system or virtual block device that is accessible to clients via a standard file system protocol (e.g., NFS and CIFS). The physical storage is a combination of a local cache of a user agent and a storage cloud. The mapping includes address references from data included in the virtual storage to one or more compressed data objects included in the physical storage. In one embodiment, at least one of the one or more compressed data objects has been compressed at least in part by replacing portions of an uncompressed data object with compression references to matching portions of previously generated compressed data objects.

At block 1310, a user agent receives a request from a client to delete information represented by data included in the virtual storage. At block 1315, the user agent deletes the data from the virtual storage. At block 1320, the user agent removes from the mapping the address reference from the deleted data.

At block 1325, reference counts for compressed data objects referenced by the data are decremented. At block 1330, any compressed data objects with a reference count of zero are deleted. The method then ends.

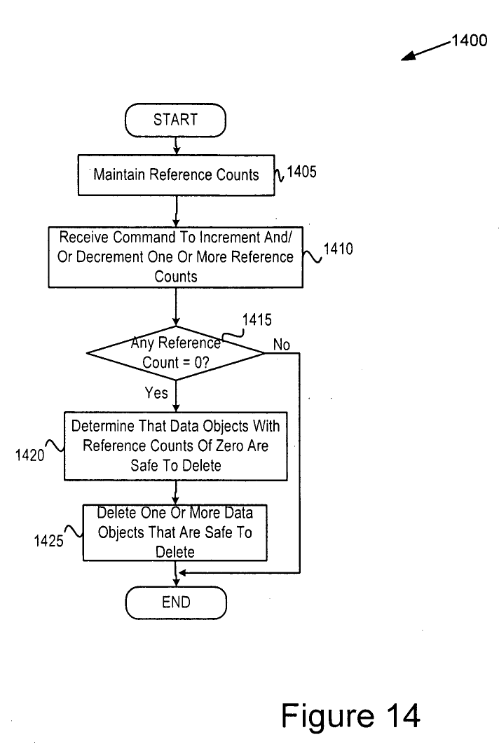

FIG. 14 is a flow diagram illustrating one embodiment of a method 1400 for managing reference counts. Method 1400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1400 is performed by central manager 405 of FIG. 4.

Referring to FIG. 14, at block 1405 of method 1400 a central manager maintains a current reference count for each compressed data object stored in a storage cloud and at caches of user agents. Each reference count is a unified reference count that includes a number of address references made to a compressed data object by data included in a virtual storage and a number of compression references made to the compressed data object by other compressed data objects.

The address references and compression references are semantically different. The address references are references made by a protocol visible reference tag (a reference that is generated because a protocol can construct an address that will eventually require this piece of data). The address reference includes address information, and in one embodiment is essentially metadata that comes from the structure of how data in the virtual storage is addressed. It is data independent, but is dependent on the structure of the virtual storage (e.g., whether it is a virtual block device or virtual file system).

The compression references are references generated during compression of other compressed data objects. The compression references are generated from data content.

For some compressed data objects, there may not be an address from the virtual storage that references it (e.g., no address reference). Thus, a compressed data object may have lost its external identity. This may occur, for example, if a user agent deleted a file or block that originally referenced the compressed data object, but it is still maintained because it is referenced by another compressed data object. Other compressed data objects may not be referenced by other compressed data objects (no compression references).

At block 1410, the central manager receives a command to increment and/or decrement one or more reference counts. The command is received from a user agent in response to the user agent generating new compressed data objects and/or deleting data in the virtual storage.

At block 1415, the central manager determines whether any reference counts have become zero. Alternatively, the central manager may determine whether the reference counts have reached some other predetermined value. If a compressed data object does have a reference count of zero (or other predetermined reference count value), the method proceeds to block 1420. Otherwise, the method ends.

At block 1420, the central manager determines that those data objects with reference counts of zero (or other predetermined values) are safe to delete. The method continues to block 1425, and one or more of the data objects that are safe to delete are deleted. In one embodiment, there is a delay between when it is determined that a compressed data object is safe to delete and when the compressed data object is actually deleted from the storage cloud. During this delay, it is still possible for new compressed data objects to reference the existing compressed data objects with the reference counts of zero. If this occurs, then the reference counts are no longer at zero, and the compressed data objects are no longer safe to delete.

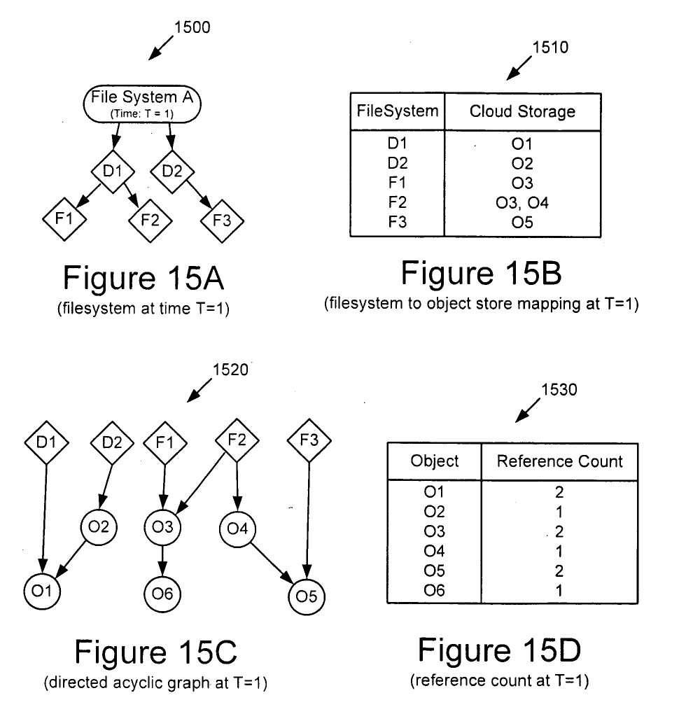

FIGS. 15A-15D illustrate the state of an example cloud storage optimized file system at a time T=1. FIG. 15A illustrates a virtual hierarchical file system 1500 at time T=1. The virtual hierarchical file system includes a first directory D1 that has a first file F1 and a second file F2. The virtual hierarchical file system further includes a second directory D2 that has a third file F3.

FIG. 15B illustrates a mapping 1510 from the virtual file system 1500 to compressed data objects stored in a cloud storage and local caches of user agents at the time T=1. As shown, directory D1 maps to data object O1, directory D2 maps to data object O2, file F1 maps to data object O3, file F2 maps to data objects O3 and O4, and file F3 maps to data object O5. In one embodiment, data in the virtual store (e.g., a file or directory in the virtual file system) can map to multiple data objects. Alternatively, each file or directory in the virtual file system may only map to a single data object.

FIG. 15C illustrates a directed acyclic graph 1520 that shows the address references from data in the virtual file system (diamond vertexes) and compression references from compressed data objects (circle vertexes). As shown, directory D1 references object O1. Directory D2 references data object O2, which in turn references data object O1. File F1 references data object O3. File F2 references data objects O3 and O4. Data object O3 references data object O6. Data object O4 references data object O5. Finally, file F3 references data object O5. Each data object may be referenced by one or more other data objects and/or by data in the virtual storage (e.g., files and/or directories in the virtual file system).

FIG. 15D illustrates a table of reference counts 1530 for each of the data objects at time T=1. As illustrated, compressed objects O1, O3 and O5 each have a reference count of 2, and data objects O2, O4 and O6 each have a reference count of 1.

FIGS. 16A and 16B illustrate embodiments of processes for generating point-in-time copies such as snapshots. A snapshot is a copy of the state of the virtual storage as it existed at a particular point in time. In one embodiment, snapshots are copies (whether virtual or physical) of the mapping between the virtual storage and the physical storage at a particular point in time. In conventional file systems, the snapshot capability is provided by a separate and distinct infrastructure from the file system. Additional machinery is added on top of traditional file systems to track a usage of the data, which is what you need to generate a snapshot.

In one embodiment, in which the reference compression scheme (discussed above) is used, the snapshot functionality is built into the cloud storage optimized file system using the same mechanisms that are used for compression. In one embodiment, the machinery to keep track of which data objects are referencing what other data objects used for compression is the same machinery as used to generate snapshots.

FIG. 16A is a flow diagram illustrating one embodiment of a method 1600 for generating snapshots of virtual storage. Method 1600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1600 is performed by a user agent 310 of FIG. 3 and/or central manager 405 of FIG. 4.

Referring to FIG. 16A, at block 1605 of method 1600 a user agent and/or central manager maintains a mapping of a virtual storage to a physical storage. The virtual storage in one embodiment is a virtual file system or virtual block device that is accessible to clients via a standard file system protocol (e.g., NFS and CIFS). The physical storage is a combination of a local cache of a user agent and a storage cloud. The mapping includes address references from data included in the virtual storage (e.g., a block number of a virtual block device or file name of a virtual file system) to one or more compressed data objects included in the physical storage. In one embodiment, at least one of the one or more compressed data objects has been compressed at least in part by replacing portions of an uncompressed data object with compression references to matching portions of previously generated compressed data objects.

At block 1610, a command to generate a snapshot is received. At block 1615, a virtual copy of the mapping is generated. The virtual copy is created by generating a new mapping whose contents are simply a pointer to the previous mapping. In one embodiment, the new mapping represents the current state of the virtual storage, and the previous mapping (to which the pointer in the new mapping points) represents the state of the virtual storage when the snapshot was taken. Since at the time that the snapshot is taken no data has changed from the previous version, a single physical copy of the mapping is all that is needed to fully represent both the snapshot and the current state of the virtual storage.

At block 1620, a command is received to change the mapping. The mapping may be changed by adding new data to the virtual storage, by removing data from the virtual storage, by modifying the data in the virtual storage, etc. The mapping may also be changed, for example, by adding new compressed data objects to the physical storage. Once the mapping has changed, the current version of the mapping is no longer identical to the snapshot. Accordingly, in one embodiment at block 1625 a copy on write is performed for the changed portions of the mapping. Subsequent to the copy on write operation, the current version of the mapping would still include a pointer to the snapshot for those portions of the mapping that are unchanged, and would contain a new mapping of data in the virtual storage to compressed data objects in the physical storage for those portions of the mapping that have changed.

At block 1630, the central manager updates the reference counts to account for new address references to compressed data objects. To the extent that the data is actually different you have to increment the reference count. The method then ends.

In one embodiment, the mapping itself is stored as a compressed data object in the storage cloud. Since each data object can be fully represented by a Cnode, in one embodiment, when a snapshot is generated, a new Cnode is generated for the snapshot that points to (or is pointed to by) a preexisting Cnode. If any blocks were changed between the preexisting Cnode and the snapshot, then the new Cnode also includes one or more additional pointers. Thus, the synergy between the core file system snapshot operation and the core operation of compression can be exploited. This means that snapshots can be performed with consuming fewer resources than snapshotting for conventional file systems.

FIG. 16B is a flow diagram illustrating another embodiment of a method 1650 for generating snapshots of virtual storage. Method 1650 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1650 is performed by a user agent 310 of FIG. 3 and/or central manager 405 of FIG. 4.

Referring to FIG. 16B, at block 1655 of method 1650 a user agent and/or central manager maintains a mapping of a virtual storage to a physical storage. The virtual storage in one embodiment is a virtual file system or virtual block device that is accessible to clients via a standard file system protocol (e.g., NFS and CIFS). The physical storage is a combination of a local cache of a user agent and a storage cloud. The mapping includes address references from data included in the virtual storage (e.g., a block number of a virtual block device or file name of a virtual file system) to one or more compressed data objects included in the physical storage. In one embodiment, at least one of the one or more compressed data objects has been compressed at least in part by replacing portions of an uncompressed data object with compression references to matching portions of previously generated compressed data objects.

At block 1660, a command to generate a snapshot is received. At block 1665, a physical copy of the mapping is generated. The physical copy is created by generating a new mapping that is independent from the original mapping. In one embodiment, the new mapping represents the current state of the virtual storage, and the previous mapping represents the state of the virtual storage when the snapshot was taken. Alternatively, the new mapping may represent the snapshot, and the previous mapping may represent the current state of the virtual storage.

At block 1670, the reference counts for compressed data objects are updated. Since the snapshots are physical copies of the mapping, the reference counts for each of the compressed data objects that were originally referenced via an address reference by the current mapping are incremented since there are now two mappings pointing to each of these compressed data objects.

At block 1675, a command is received to change the current mapping. The mapping may be changed by adding new data to the virtual storage, by removing data from the virtual storage, by modifying the data in the virtual storage, etc. The mapping may also be changed, for example, by adding new compressed data objects to the physical storage.

At block 1680, the reference counts are updated to reflect the changed mapping. For example, if data was deleted from the virtual storage, then the address references of that data to one or more compressed data objects are removed from the current mapping. The reference counts for these compressed data objects would be decremented accordingly. The method then ends.

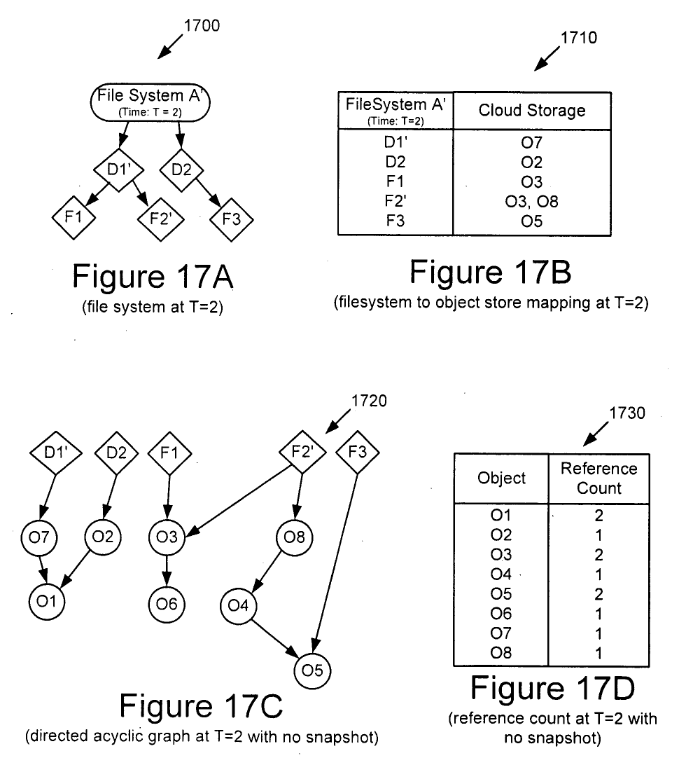

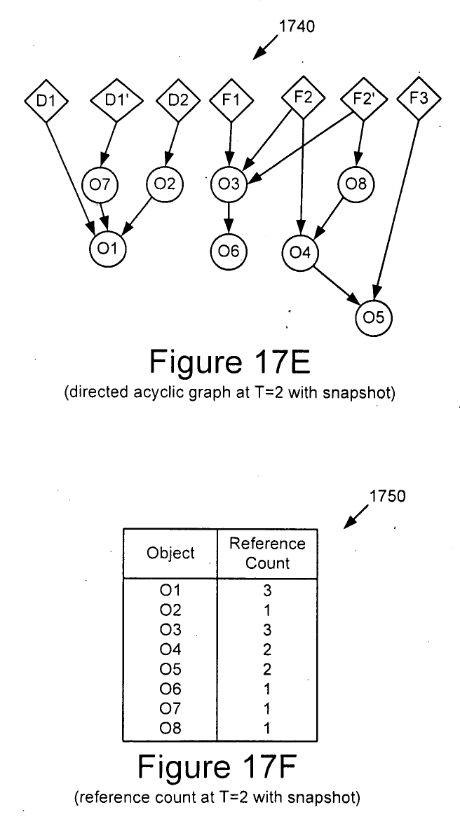

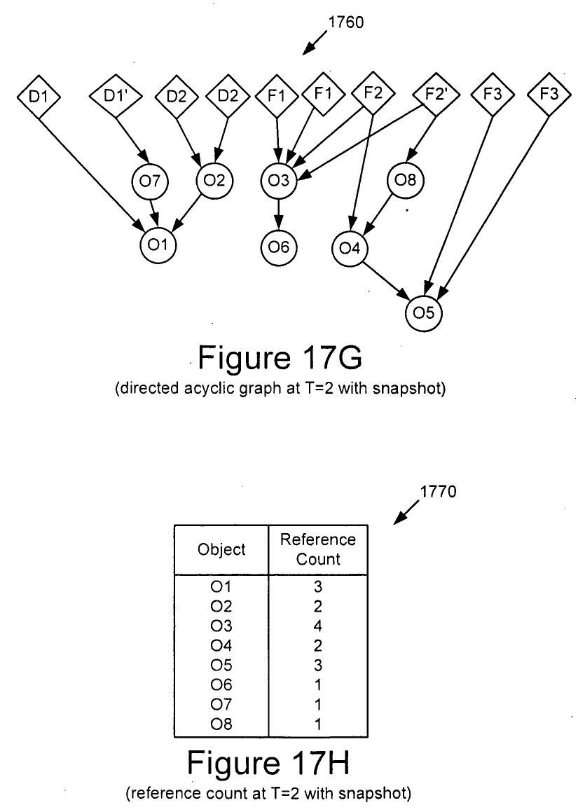

FIGS. 17A-17D illustrate the state of an example cloud storage optimized file system at a time T=2. The example cloud storage optimized file system in this example originally had a state at a time T=1 as shown in FIGS. 15A-15D. In this example, no snapshot was performed between time T=1 and T=2.

FIG. 17A illustrates a virtual hierarchical file system 1700 at time T=2. The virtual hierarchical file system includes a first directory D1′ that has a first file F 1 and a second file F2′. The file F2 was changed to F2′ between time T=1 and T=2. Accordingly, the directory D1 also changed to D1′. The virtual hierarchical file system further includes a second directory that has a third file F3, which is unchanged from T=1.

FIG. 17B illustrates a mapping 1710 from the virtual file system to compressed data objects stored in a cloud storage and local caches of user agents at the time T=2. As shown, directory D1′ maps to a new data object O7, directory D2 still maps to data object O2, file F1 still maps to data object O3, file F2 maps to data objects O3 and O8, and file F3 still maps to data object O5.

FIG. 17C illustrates a directed acyclic graph 1720 that show the address references from data in the virtual file system (diamond vertexes) and compression references from compressed data objects (circle vertexes). As shown, directory D1′ references data object O7, which in turn references data object O1. Directory D2 references data object O2, which in turn references data object O1. File F1 references data object O3. File F2′ references data objects O3 and O8. Data object O3 references data object O6. Data object O8 references data object O4. Data object O4 references data object O5. Finally, file F3 references data object O5. Though directory D1′ is shown to reference O7, which in turn references O1, in one embodiment directory D1′ may instead directly reference O7 and O1. Similarly, F2′ could instead reference O8 and O4 directly.

FIG. 17D illustrates a table of reference counts 1730 for each of the data objects at time T=2. As illustrated, compressed objects O1, O3 and O5 each have a reference count of 2, and data objects O2, O4 and O6 each have a reference count of 1.

FIGS. 17E-17F illustrate the state of the example cloud storage optimized file system as shown in FIGS. 17A-17D at the time T=2. However, the example cloud storage optimized file system in FIGS. 17E-17F show the state of the cloud storage optimized file system if a virtual point in time copy were taken before the time T=2.

FIG. 17E illustrates a directed acyclic graph 1740 that shows the address references from data in the virtual file system (diamond vertexes) and compression references from compressed data objects (circle vertexes). Because a virtual point-in-time copy of the virtual file system was generated before time T=2, the cloud storage optimized file system now includes references from both the current mapping and the mapping saved when the point-in-time (PIT) copy was made. As shown, directory D1 (from the PIT copy of the mapping) references data object O1. Directory D1′ (from the present mapping) references data object O7, which in turn references data object O1. Directory D2 was unchanged between T=1 and T=2, therefore there is one reference from D2 to data object O2, which in turn references data object O1. File F1 was also unchanged, and so still references data object O3. File F2 (from the PIT copy of the mapping) references O3 and O4. File F2′ (from the current mapping) references data objects O3 and O8. Data object O8 references data object O4. Data object O3 references data object O6. Data object O8 references data object O4. Data object O4 references data object O5. Finally, file F3 was unchanged between T=1 and T=2, and references data object O5.

FIG. 17F illustrates a table of reference counts 1750 for each of the data objects at time T=2 after a virtual PIT copy was generated. As illustrated, compressed objects O1 and O3 now include a reference count of 3. Compressed data objects O4 and O5 each have a reference count of 2. Data objects O2, O6, O7 and O8 each have a reference count of 1.

FIGS. 17G-17H illustrate the state of the example cloud storage optimized file system as shown in FIGS. 17A-17F at the time T=2. However, the example cloud storage optimized file system in FIGS. 17G-17H show the state of the cloud storage optimized file system if a physical point in time copy were taken before the time T=2.

FIG. 17G illustrates a directed acyclic graph 1760 that shows the address references from data in the virtual file system (diamond vertexes) and compression references from compressed data objects (circle vertexes). Because a virtual point-in-time copy of the virtual file system was generated before time T=2, the cloud storage optimized file system now includes references from both the current mapping and the mapping saved when the point-in-time copy was made. The directed acyclic graph 1760 is closely aligned with directed acyclic graph 1740 of FIG. 17E, including all of the references shown in directed acyclic graph 1740. However, because a physical PIT copy was generated prior to T=2 for FIG. 17G, directed acyclic graph 1760 also includes two references from each of D2, F4 and F3.

FIG. 17H illustrates a table of reference counts 1770 for each of the data objects at time T=2 after a physical PIT copy was generated. As illustrated, data object O3 includes a reference count of 4. Data objects O1 and O5 include a reference count of 3. Data objects O2 and O4 each have a reference count of 2. Data objects O6, O7 and O8 each have a reference count of 1.

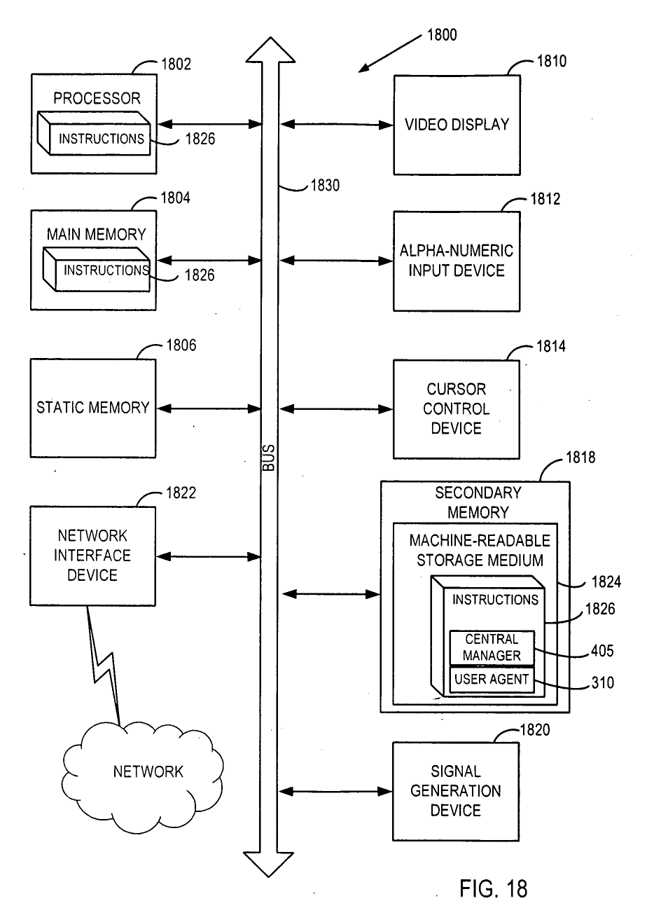

FIG. 18 illustrates a diagrammatic representation of a machine in the exemplary form of a computer system 1800 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1800 includes a processor 1802, a main memory 1804 (e.g., read-only memory (ROM), flash memory, dynamic random access memory (DRAM) such as synchronous DRAM (SDRAM) or Rambus DRAM (RDRAM), etc.), a static memory 1806 (e.g., flash memory, static random access memory (SRAM), etc.), and a secondary memory 1818 (e.g., a data storage device), which communicate with each other via a bus 1830.

Processor 1802 represents one or more general-purpose processing devices such as a microprocessor, central processing unit, or the like. More particularly, the processor 1802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1802 may also be one or more special-purpose processing devices such as an application specific integrated circuit (ASIC), a field programmable gate array (FPGA), a digital signal processor (DSP), network processor, or the like. Processor 1802 is configured to execute instructions 1826 (e.g., processing logic) for performing the operations and steps discussed herein.

The computer system 1800 may further include a network interface device 1822. The computer system 1800 also may include a video display unit 1810 (e.g., a liquid crystal display (LCD) or a cathode ray tube (CRT)), an alphanumeric input device 1812 (e.g., a keyboard), a cursor control device 1814 (e.g., a mouse), and a signal generation device 1820 (e.g., a speaker).

The secondary memory 1818 may include a machine-readable storage medium (or more specifically a computer-readable storage medium) 1824 on which is stored one or more sets of instructions 1826 (e.g., software) embodying any one or more of the methodologies or functions described herein. The instructions 1826 may also reside, completely or at least partially, within the main memory 1804 and/or within the processing device 1802 during execution thereof by the computer system 1800, the main memory 1804 and the processing device 1802 also constituting machine-readable storage media.

The machine-readable storage medium 1824 may also be used to store the user agent 310 of FIG. 3 and/or central manager 405 of FIG. 4, and/or a software library containing methods that call the user agent and/or central manager. While the machine-readable storage medium 1824 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method comprising:
maintaining, by a computing device, a mapping of a virtual storage to a physical storage, the mapping including address references from data included in the virtual storage to one or more compressed data objects included in the physical storage, wherein at least one of the one or more compressed data objects having been compressed at least in part by replacing portions of an uncompressed data object with compression references to matching portions of previously generated compressed data objects.

2. The method of claim 1, further comprising:
responding, by the computing device, to a request to access information represented by the data from a client by transferring one or more first compressed data objects referenced by the data via the address references and one or more second compressed data objects referenced by the one or more first compressed data objects via the compression references to the client.

3. The method of claim 2, wherein the responding is performed using a file system protocol, and wherein the compressed data objects are stored using an additional protocol that is not a file system protocol.

4. The method of claim 3, wherein the additional protocol is at least one of HTTP, SOAP and REST protocols.

5. The method of claim 1, wherein the virtual storage is a virtual block device or a virtual file system.

6. The method of claim 1, wherein each of the one or more compressed data objects has a reference count representing usage of the compressed data object by the data and by other compressed data objects

7. The method of claim 6, wherein the reference count includes the compression references to the compressed data object and the address references to the compressed data object.

8. The method of claim 6, further comprising:
generating a new compressed data object at least in part by replacing portions of a new uncompressed data object with references to matching portions of the one or more compressed data objects;
incrementing a reference count for each of the one or more compressed data objects having the matching portions; and
storing the new compressed data object in the physical storage.

9. The method of claim 6, further comprising:
generating a point-in-time copy of the data, wherein the point-in-time copy includes at least one of the address references of the data to the one or more compressed data objects.

10. The method of claim 9, further comprising:
subsequent to generating the point-in-time copy, receiving a request to make a modification to the data;
generating a new compressed data object that includes the modification;
updating the mapping to include a new address reference from the data to the new compressed data object; and
incrementing a reference count for the new compressed data object and for at least one of the one or more compressed data objects previously referenced by the virtual data.

11. The method of claim 6, further comprising:
receiving a command to delete the data;
removing the data from the virtual storage;
removing from the mapping the address references from the data;
decrementing the reference counts for the one or more compressed data objects that had been referenced by the data via the removed address references; and
deleting the compressed data objects for which the reference counts are zero.

12. The method of claim 1, further comprising:
storing the one or more compressed data objects in the physical storage, wherein the physical storage includes a storage cloud.

13. A method comprising:
managing reference counts for a plurality of compressed data objects by a computing device, wherein each of the compressed data objects has a reference count representing a number of address references made to the compressed data object by data included in a virtual storage and a number of compression references made to the compressed data object by other compressed data objects; and
determining, by the computing device, when it is safe to delete a compressed data object based on the reference count for the compressed data object.

14. The method of claim 13, wherein the address references are based on a mapping of the virtual storage, which includes the data, to a physical storage that includes the compressed data objects.

15. The method of claim 13, wherein the compressed data objects are generated at least in part by replacing portions of uncompressed data objects with compression references to matching portions of previously generated compressed data objects.

16. The method of claim 13, further comprising:
in response to generation of a new compressed data object that was generated at least in part by replacing portions of a new uncompressed data object with references to matching portions of the plurality of compressed data objects, incrementing reference counts for the plurality of compressed data objects having the matching portions.

17. The method of claim 13, further comprising:
in response to a request to modify the data after generation of a point-in-time copy of the data, incrementing a reference count for one or more of the plurality of compressed data objects that had been referenced by the data via an address reference.

18. The method of claim 13, further comprising:
in response to a request to delete the data from the virtual storage, decrementing the reference counts for the plurality of compressed data objects that had been referenced by the data via the address references.

19. The method of claim 13, further comprising:
causing those compressed data objects for which the reference count becomes zero to be deleted.

20. A computer readable storage medium including instructions that, when executed by a processing system, cause the processing system to perform a method comprising:
maintaining, by a computing device, a mapping of a virtual storage to a physical storage, the mapping including address references from data included in the virtual storage to one or more compressed data objects included in the physical storage, wherein at least one of the one or more compressed data objects having been compressed at least in part by replacing portions of an uncompressed data object with compression references to matching portions of previously generated compressed data objects.

21. The computer readable storage medium of claim 20, the method further comprising:
responding, by the computing device, to a request to access information represented by the data from a client by transferring one or more first compressed data objects referenced by the data via the address references and one or more second compressed data objects referenced by the one or more first compressed data objects via the compression references to the client.

22. The computer readable storage medium of claim 21, wherein the responding is performed using a file system protocol, and wherein the compressed data objects are stored using an additional protocol that is not a file system protocol.

23. The computer readable storage medium of claim 20, wherein each of the one or more compressed data objects has a reference count representing usage of the compressed data object by the data and by other compressed data objects, wherein the reference count includes the compression references to the compressed data object and the address references to the compressed data object.

24. The computer readable storage medium of claim 23, the method further comprising:
generating a new compressed data object at least in part by replacing portions of a new uncompressed data object with references to matching portions of the one or more compressed data objects;
incrementing a reference count for each of the one or more compressed data objects having the matching portions; and
storing the new compressed data object in the physical storage.

25. The computer readable storage medium of claim 23, the method further comprising:
generating a point-in-time copy of the data, wherein the point-in-time copy includes at least one of the address references of the data to the one or more compressed data objects.

26. The computer readable storage medium of claim 25, the method further comprising:
subsequent to generating the point-in-time copy, receiving a request to make a modification to the data;
generating a new compressed data object that includes the modification;
updating the mapping to include a new address reference from the data to the new compressed data object; and
incrementing a reference count for the new compressed data object and for at least one of the one or more compressed data objects previously referenced by the virtual data.

27. The computer readable storage medium of claim 23, the method further comprising:
receiving a command to delete the data;
removing the data from the virtual storage;
removing from the mapping the address references from the data;
decrementing the reference counts for the one or more compressed data objects that had been referenced by the data via the removed address references; and
deleting the compressed data objects for which the reference counts are zero.

28. A computer readable storage medium including instructions that, when executed by a processing system, cause the processing system to perform a method comprising:
managing reference counts for a plurality of compressed data objects by a computing device, wherein each of the compressed data objects has a reference count representing a number of address references made to the compressed data object by data included in a virtual storage and a number of compression references made to the compressed data object by other compressed data objects; and
determining, by the computing device, when it is safe to delete a compressed data object based on the reference count for the compressed data object.

29. The computer readable storage medium of claim 28, wherein the address references are based on a mapping of the virtual storage, which includes the data, to a physical storage that includes the compressed data objects.

30. The computer readable storage medium of claim 28, wherein the compressed data objects are generated at least in part by replacing portions of uncompressed data objects with compression references to matching portions of previously generated compressed data objects.

31. The computer readable storage medium of claim 28, the method further comprising:
in response to generation of a new compressed data object that was generated at least in part by replacing portions of a new uncompressed data object with references to matching portions of the plurality of compressed data objects, incrementing reference counts for the plurality of compressed data objects having the matching portions.

32. The computer readable storage medium of claim 28, the method further comprising:
in response to a request to modify the data after generation of a point-in-time copy of the data, incrementing a reference count for one or more of the plurality of compressed data objects that had been referenced by the data via an address reference.

33. The computer readable storage medium of claim 28, the method further comprising:
in response to a request to delete the data from the virtual storage, decrementing the reference counts for the plurality of compressed data objects that had been referenced by the data via the address references.

34. The computer readable storage medium of claim 28, the method further comprising:
causing those compressed data objects for which the reference count becomes zero to be deleted.

35. A computing apparatus comprising:
a memory including instructions for a user agent; and
a processor, connected with the memory, to execute the instructions, wherein the instructions cause the processor to:
maintain a mapping of a virtual storage to a physical storage, the mapping including address references from data included in the virtual storage to one or more compressed data objects included in the physical storage, wherein at least one of the one or more compressed data objects having been compressed at least in part by replacing portions of an uncompressed data object with compression references to matching portions of previously generated compressed data objects.

36. The computing apparatus of claim 35, further comprising:
the instructions to cause the processor to respond to a request to access information represented by the data from a client by transferring one or more first compressed data objects referenced by the data via the address references and one or more second compressed data objects referenced by the one or more first compressed data objects via the compression references to the client.

37. The computing apparatus of claim 36, wherein the processor to respond using a file system protocol, and wherein the compressed data objects are stored using an additional protocol that is not a file system protocol.

38. The computing apparatus of claim 35, wherein each of the one or more compressed data objects has a reference count representing usage of the compressed data object by the data and by other compressed data objects, and wherein the reference count includes the compression references to the compressed data object and the address references to the compressed data object.

39. The computing apparatus of claim 38, further comprising the instructions to cause the processor to:
generate a new compressed data object at least in part by replacing portions of a new uncompressed data object with references to matching portions of the one or more compressed data objects;
increment a reference count for each of the one or more compressed data objects having the matching portions; and
store the new compressed data object in the physical storage.

40. The computing apparatus of claim 38, further comprising the instructions to cause the processor to:
generate a point-in-time copy of the data, wherein the point-in-time copy includes at least one of the address references of the data to the one or more compressed data objects.

41. The computing apparatus of claim 40, further comprising the instructions to cause the processor to:
subsequent to generating the point-in-time copy, receive a request to make a modification to the data;
generate a new compressed data object that includes the modification;
update the mapping to include a new address reference from the data to the new compressed data object; and
increment a reference count for the new compressed data object and for at least one of the one or more compressed data objects previously referenced by the virtual data.

42. The computing apparatus of claim 38, further comprising the instructions to cause the processor to:
receive a command to delete the data;
remove the data from the virtual storage;
remove from the mapping the address references from the data;
decrement the reference counts for the one or more compressed data objects that had been referenced by the data via the removed address references; and
delete the compressed data objects for which the reference counts are zero.

43. A computing apparatus comprising:
a memory including instructions for a user agent; and
a processor, connected with the memory, to execute the instructions, wherein the instructions cause the processor to:
manage reference counts for a plurality of compressed data objects, wherein each of the compressed data objects has a reference count representing a number of address references made to the compressed data object by data included in a virtual storage and a number of compression references made to the compressed data object by other compressed data objects; and
determine when it is safe to delete a compressed data object based on the reference count for the compressed data object.

44. The computing apparatus of claim 43, wherein the address references are based on a mapping of the virtual storage, which includes the data, to a physical storage that includes the compressed data objects.

45. The computing apparatus of claim 43, wherein the compressed data objects are generated at least in part by replacing portions of uncompressed data objects with compression references to matching portions of previously generated compressed data objects.

46. The computing apparatus of claim 43, further comprising the instructions to cause the processor to:
in response to generation of a new compressed data object that was generated at least in part by replacing portions of a new uncompressed data object with references to matching portions of the plurality of compressed data objects, increment reference counts for the plurality of compressed data objects having the matching portions.

47. The computing apparatus of claim 43, further comprising the instructions to cause the processor to:
in response to a request to modify the data after generation of a point-in-time copy of the data, increment a reference count for one or more of the plurality of compressed data objects that had been referenced by the data via an address reference.

48. The computing apparatus of claim 43, further comprising the instructions to cause the processor to:
in response to a request to delete the data from the virtual storage, decrement the reference counts for the plurality of compressed data objects that had been referenced by the data via the address references.

49. The computing apparatus of claim 43, further comprising the instructions to cause the processor to:
cause those compressed data objects for which the reference count becomes zero to be deleted.
